(19) United States
(12) Patent Application Publication
(10) Pub. No.: US 2025/0283696 A1
(43) Pub. Date: Sep. 11, 2025

(54) RISER ASSEMBLY WITH INTEGRAL POWER SUPPLY AND WEAPON SYSTEM EMPLOYING THE SAME

(71) Applicant: WILCOX INDUSTRIES CORP., Newington, NH (US)

(72) Inventors: James W. Teetzel, Portsmouth, NH (US); Joshua R. Beaulieu, Sanbornville, NH (US)

(21) Appl. No.: 19/051,594

(22) Filed: Feb. 12, 2025

Related U.S. Application Data
(60) Provisional application No. 63/563,395, filed on Mar. 10, 2024.

(51) Int. Cl. F41G 11/00; F41G 3/14

(52) U.S. Cl. CPC F41G 11/001; F41G 3/145

(57) ABSTRACT

A riser mount system includes a housing having a lower surface configured to engage a weapon accessory interface and an upper surface opposite the lower surface configured to engage a fire control system. A peripheral wall extending between the lower surface and the upper surface, wherein the housing defines an interior compartment. A riser circuit assembly disposed with the interior compartment, which is configured to receive one or more batteries for electrical coupling to the riser circuit assembly. A first electrical connector is disposed on the first surface and is structured and operable to electrically couple the one or more batteries to a fire control system. A second electrical connector disposed on the second surface and is structured and operable to electrically couple the one or more batteries to one or more devices on the weapon accessory interface.

### CROSS REFERENCE TO RELATED APPLICATION

This application claims the priority benefit of U.S. provisional application No. 63/563,395 filed Mar. 10, 2024. The aforementioned application is incorporated herein by reference in its entirety.

### INCORPORATION BY REFERENCE

This application is related to U.S. provisional application No. 63/538,265 filed Sep. 13, 2023, and U.S. nonprovisional application Ser. No. 18/830,125 filed Sep. 10, 2024. Each of the aforementioned applications is incorporated herein by reference in its entirety.

### BACKGROUND

The present invention relates to weapon systems and, in particular, to a weapon system including a riser assembly attachable to a weapon accessory interface for mounting a fire control system.

As shown in FIG. 46, there is shown a weapon operator holding a rifle using a conventional “C grip,” C-clamp grip,” or “thumb-over grip,” which can be utilized for certain shooting techniques and tactical scenarios, or, as a matter of individual preference. In this context, the shooter typically holds the rifle with one hand on the pistol grip, as usual, and the other, support hand is positioned toward the fore-end of the rifle with the thumb positioned over the top of the handguard. While this grip provides good control and stability of the rifle, particularly during rapid or sustained fire, positioning the support hand over the top of the handguard and at the fore-end of the rifle can potentially block scopes, sights, or other aiming devices mounted on the accessory interface, thereby obstructing the operator's sight picture through the aiming device.

A riser is an accessory that attaches to a weapon accessory mounting platform and raises the mounting point of the aiming accessory device. Elevating the aiming device above the handguard creates additional clearance for the support hand, allowing the operator to utilize the C-grip without obstructing the line of sight through the aiming device or, in the case of a laser sight, without blocking beam emitted by the aiming laser.

The present invention contemplates an improved riser assembly with power supply which utilizes the space beneath the riser, which would normally be wasted or unused space, wherein the riser houses one or more batteries while elevating an aiming accessory to accommodate a C grip or thumb-over shooting technique.

### SUMMARY

The present disclosure provides a riser assembly including one or more batteries which power the fire control system. Circuitry within the riser assembly provides power to the fire control system and other accessories. In embodiments, the circuitry within the riser assembly also transmits data and control signals from the fire control system to one or more associated devices and vice versa. In this manner, the fire control system can be used to activate and control accessories mounted on the weapon handguard and accessories on the weapon handguard can be used to activate and control the fire control system. In embodiments, data can be transmitted between the fire control system and one or more associated accessory devices.

In a further aspect, a modular keypad assembly with an integral illuminator is attachable to the weapon accessory interface and is also powered by the batteries within the riser assembly. In certain embodiments, the modular keypad assembly includes an integral camera. The keypad includes button or key input controls which can be used to control operation of the fire control system. Likewise, buttons or other input controls on the fire control system can be used to control operation of the illuminator and optional camera on the modular keypad assembly. In yet a further aspect, a flashlight assembly is attachable to the weapon accessory interface and is powered remotely by the one or more batteries in the riser assembly. Various advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is an isometric view of a firearm embodying the weapon system in accordance with an exemplary embodiment, taken generally from the front, above, and the shooter's right side.

FIG. 2 is an isometric view of the firearm and weapon system appearing in FIG. 1 taken generally from the front, above, and the shooter's left side.

FIG. 3 is a right side view of the firearm and weapon system appearing in FIG. 1.

FIG. 4 is a left side view of the firearm and weapon system appearing in FIG. 1.

FIG. 5 is an isometric view of the firearm and weapon system appearing in FIG. 1 taken generally from the front, below, and the shooter's right side.

FIG. 6 is an isometric view of the firearm and weapon system appearing in FIG. 1 taken generally from the front, below, and the shooter's left side.

FIG. 7 is a front view of the firearm and weapon system appearing in FIG. 1.

FIG. 7A is a partially exploded isometric view of the firearm appearing in FIG. 1, illustrating the manner of attachment of a keypad assembly and an associated trim plate or interface cover.

FIG. 8 is an isometric view of an exemplary embodiment riser assembly taken generally from the front, above, and left.

FIG. 9 is a top view of the riser assembly appearing in FIG. 8.

FIG. 10 is an isometric view of the riser assembly appearing in FIG. 8, taken generally from the rear, above, and left.

FIG. 11 is a front view of the riser assembly appearing in FIG. 8.

FIG. 12 is a left side view of the riser assembly appearing in FIG. 8.

FIG. 13 is a rear view of the riser assembly appearing in FIG. 8.

FIG. 14 is an isometric view of the riser assembly appearing in FIG. 8, taken generally from the front, below, and left.

FIG. 15 is a bottom view of the riser assembly appearing in FIG. 8.

FIG. 16 is an isometric view of the riser assembly appearing in FIG. 8, taken generally from the rear, below, and left.

FIG. 17 is an exploded view of the weapon system appearing in FIG. 1.

FIG. 18 is an isometric view of an exemplary embodiment modular keypad assembly taken generally from the front, above, and right.

FIG. 19 is a top view of the modular keypad assembly appearing in FIG. 18.

FIG. 20 is an isometric view of the modular keypad assembly appearing in FIG. 18, taken generally from the front, above, and left.

FIG. 21 is a right side view of the modular keypad assembly appearing in FIG. 18.

FIG. 22 is a front view of the modular keypad assembly appearing in FIG. 18.

FIG. 23 is a left side view of the modular keypad assembly appearing in

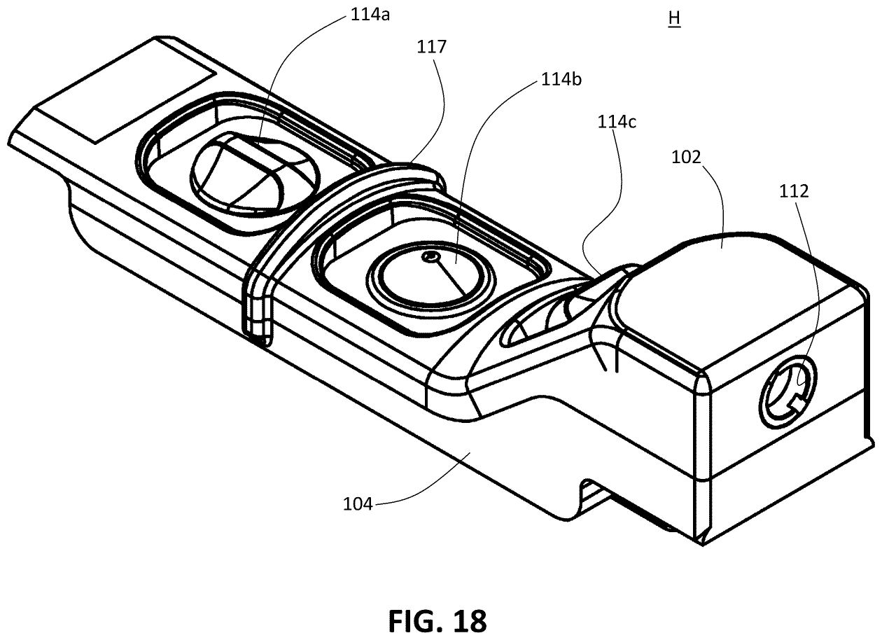

FIG. 18.

FIG. 24 is an isometric view of the modular keypad assembly appearing in FIG. 18, taken generally from the front, below, and right.

FIG. 25 is a bottom view of the modular keypad assembly appearing in FIG. 18.

FIG. 26 is an isometric view of the modular keypad assembly appearing in FIG. 18, taken generally from the front, below, and left.

FIG. 27 is an isometric view of a flashlight assembly in accordance with an exemplary embodiment, taken generally from above, the front, and right.

FIG. 28 is a top view of the riser assembly appearing in FIG. 27.

FIG. 29 is an isometric view of the riser assembly appearing in FIG. 27, taken generally from the front, above, and left.

FIG. 30 is a right side view of the riser assembly appearing in FIG. 27.

FIG. 31 is a front view of the riser assembly appearing in FIG. 27.

FIG. 32 is a left side view of the riser assembly appearing in FIG. 27.

FIG. 33 is an isometric view of the riser assembly appearing in FIG. 27, taken generally from the front, below, and right.

FIG. 34 is a bottom view of the riser assembly appearing in FIG. 27.

FIG. 35 is an isometric view of the riser assembly appearing in FIG. 27, taken generally from the front, below, and left.

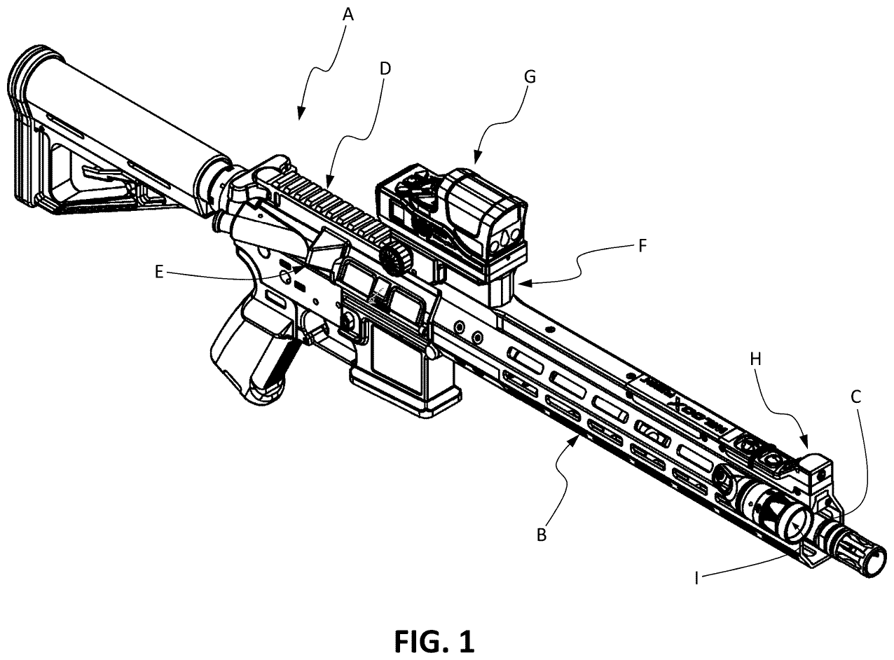

FIG. 35A is a fragmentary isometric view of the muzzle end of the firearm appearing in FIG. 1 with the flashlight assembly attached and illustrating the manner of electrically connecting the flashlight assembly to the handguard circuit assembly.

FIGS. 35B and 35C are side and isometric views, respectively, of the flashlight assembly illustrating the manner of attachment to an accessory interface slot on the handguard assembly.

FIG. 36 is an isometric view of a second exemplary embodiment modular keypad assembly taken generally from the front, above, and right.

FIG. 37 is a top view of the modular keypad assembly appearing in FIG. 36.

FIG. 38 is an isometric view of the modular keypad assembly appearing in FIG. 36, taken generally from the front, above, and left.

FIG. 39 is a right side view of the modular keypad assembly appearing in FIG. 36.

FIG. 40 is a front view of the modular keypad assembly appearing in FIG. 36.

FIG. 41 is a left side view of the modular keypad assembly appearing in FIG. 36.

FIG. 42 is an isometric view of the modular keypad assembly appearing in FIG. 36, taken generally from the front, below, and right.

FIG. 43 is a bottom view of the modular keypad assembly appearing in FIG. 36.

FIG. 44 is an isometric view of the modular keypad assembly appearing in FIG. 36, taken generally from the front, below, and left.

FIG. 45 is a schematic block diagram illustrating the weapon system in accordance with the present disclosure.

FIG. 46 is an image illustrating the C-grip or thumb over grip being utilized for a rifle.

### DETAILED DESCRIPTION OF THE PREFERRED EMBODIMENT(S)

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention, and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

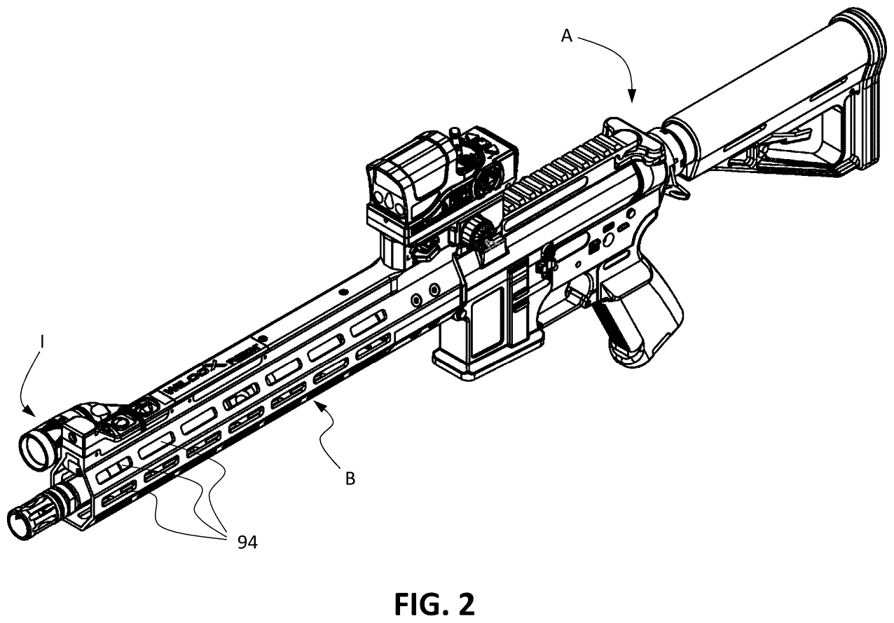

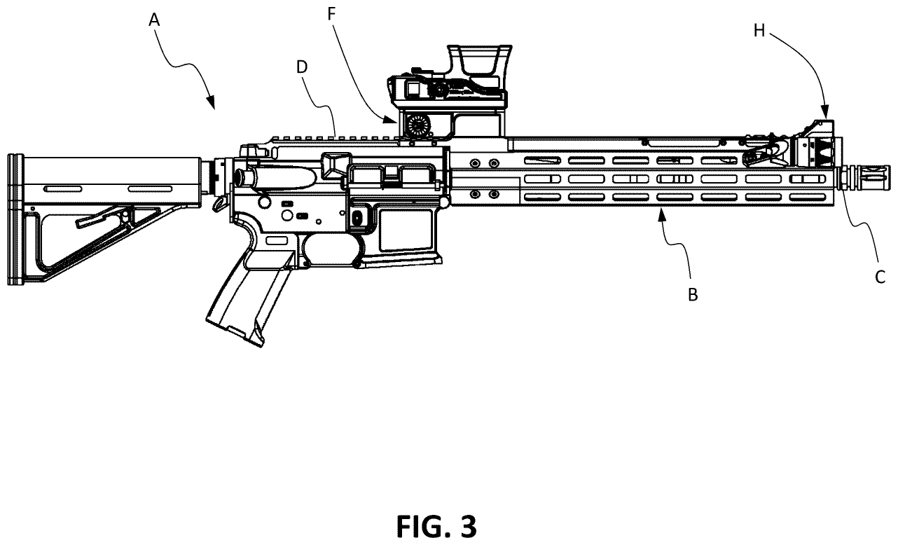

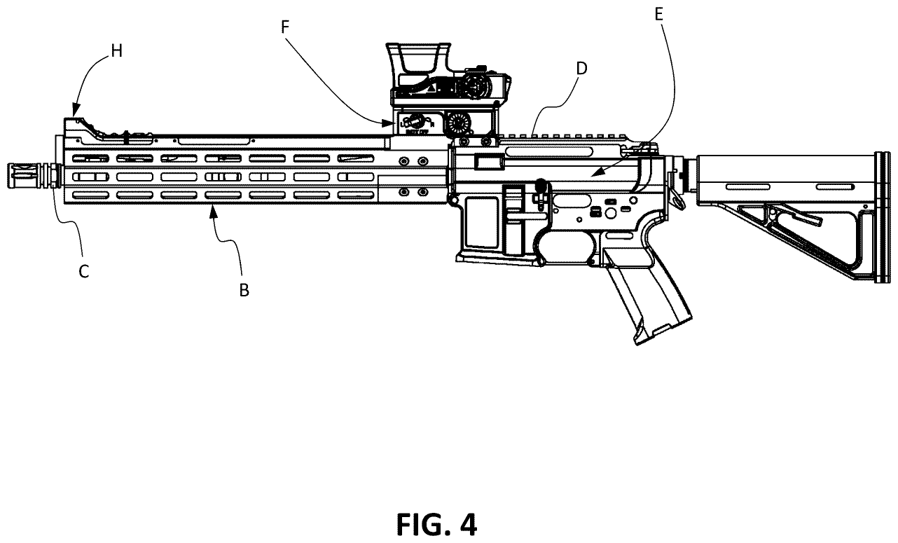

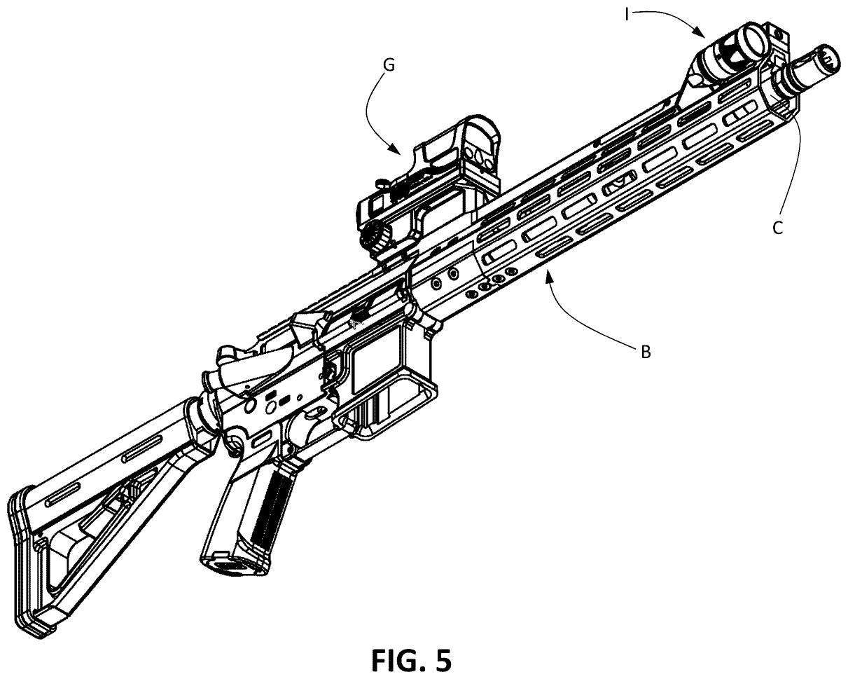

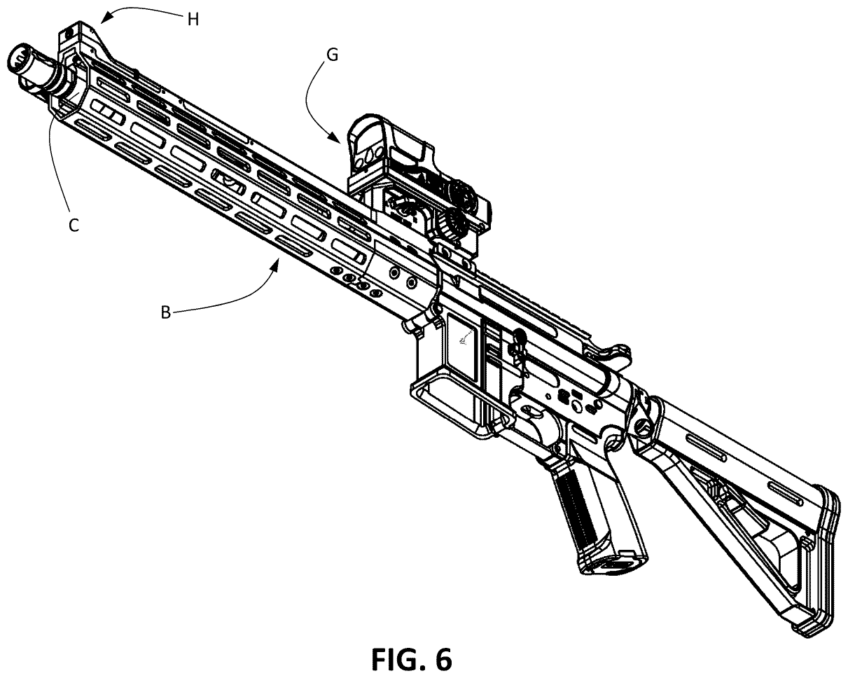

Referring now to the drawings, FIGS. 1-7A illustrate a weapon A, such as a firearm, having a handguard assembly B disposed about a barrel C of the firearm A. The handguard assembly B is both a protective and accessory-mounting component in that it shields the operator's hand from the hot barrel during use while also serving as a mounting platform for various accessories, such as grips, lights, lasers, and aiming devices. In embodiments, the weapon A also includes an accessory rail D, such as a Picatinny rail or the like, disposed on a receiver portion E of the firearm A. The handguard assembly B and the accessory rail D may also be referred to herein individually or collectively as a “weapon accessory interface.”

A riser assembly F is secured to the weapon accessory interface, e.g., using threaded fasteners or the like. A fire control system G, in turn, is secured to the riser assembly F. As used herein, the term “fire control system” refers to systems that aid in aiming and firing weapons. Exemplary fire control systems include, but are not limited to, reflex sights, red dot sights, laser sights, holographic sights, night vision scopes, thermal imaging scopes, digital rifle scopes, and the like. In embodiments, the fire control system may be a fire control system in the Wilcox GSS, Wilcox RAAM GSS, Wilcox RAAM GSS M, Wilcox BOSS, and Wilcox BOSS Xe product lines, available from Wilcox Industries Corp. of Newington, New Hampshire.

A modular or remote keypad assembly H is disposed at the muzzle end of the handguard assembly B. A flashlight assembly I is secured to the handguard assembly B via a selected interface slot 94. Although the flashlight assembly I is shown positioned at the top right position of the handguard assembly B, it can alternatively be positioned at any other desired position on the handguard assembly where an interface slot 94 is located.

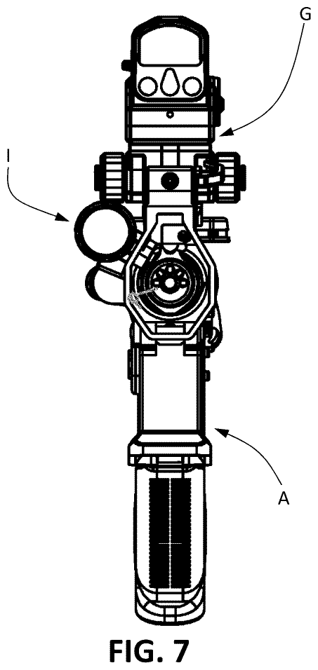

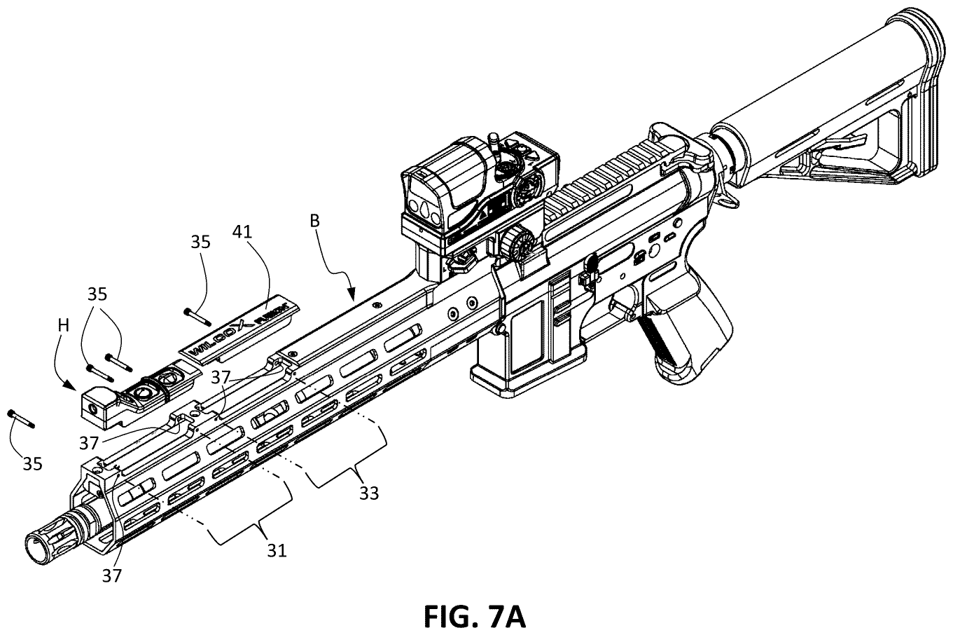

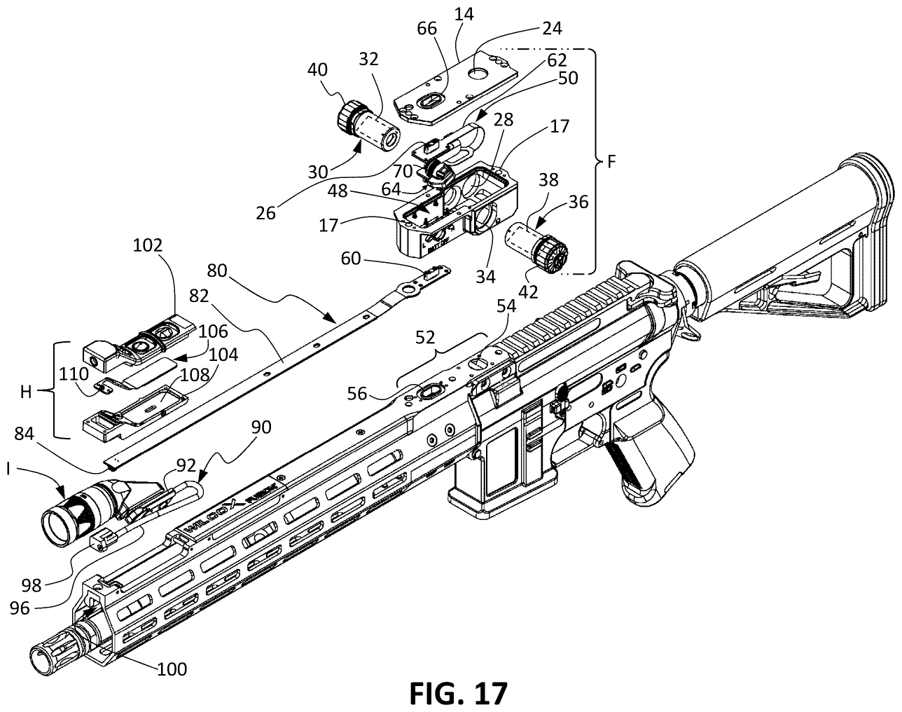

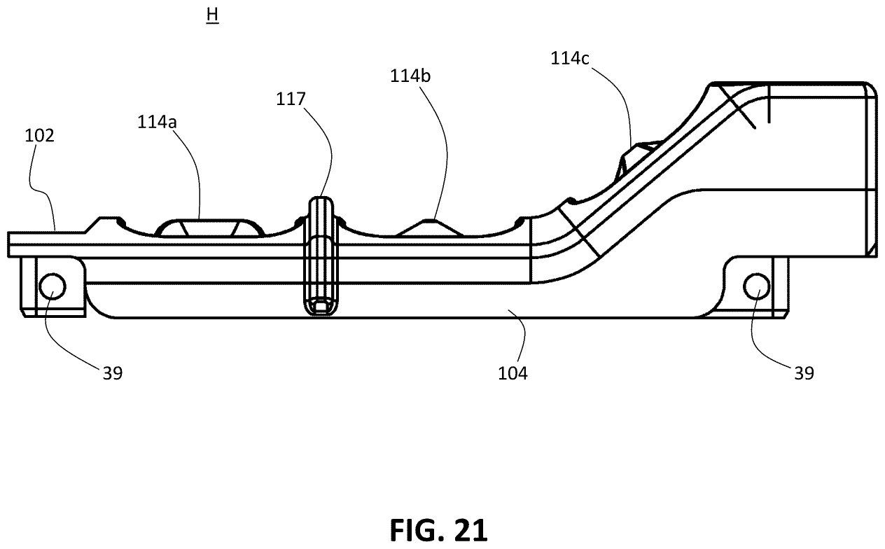

As best seen in FIG. 7A, in certain embodiments, the handguard assembly B includes a plurality of like fastening locations 31, 33 which include openings in the upper surface of the handguard assembly B to provide access to a handguard circuit assembly 80 (see FIG. 17) disposed within the handguard assembly B. In the illustrated embodiment, the keypad assembly H is secured to the first fastening location 31 via threaded fasteners 35 which engage aligned openings 37 in the handguard assembly B and pass through complementary transverse openings 39 (see FIG. 21) in the keypad assembly lower housing shell 104 (see FIG. 17). The second handguard assembly fastening location 33 includes a cover plate or trim plate 41 to cover the interface opening 33 when not in use. By providing two fastening locations 31, 33, the keypad assembly H and cover plate 41 can swap places such that the keypad assembly H is secured at the fastening location 33 and the cover plate 41 is secured at the fastening location 31. In this manner, the keypad assembly H can be positioned closer to the operator's body, e.g., to accommodate operators with shorter arms or otherwise according to their ergonomic preferences. It will be recognized that in alternative embodiments, a handguard assembly with a single keypad fastening location is also contemplated.

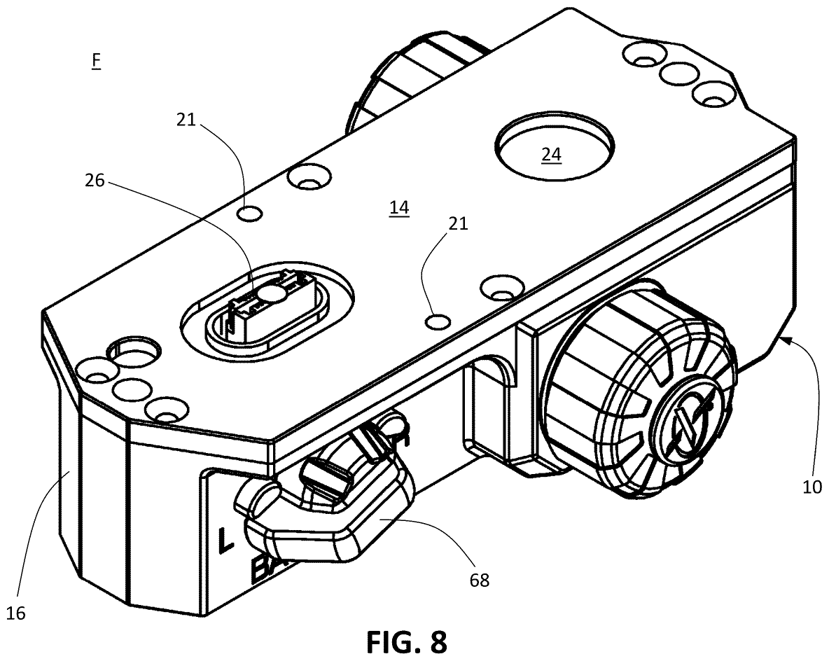

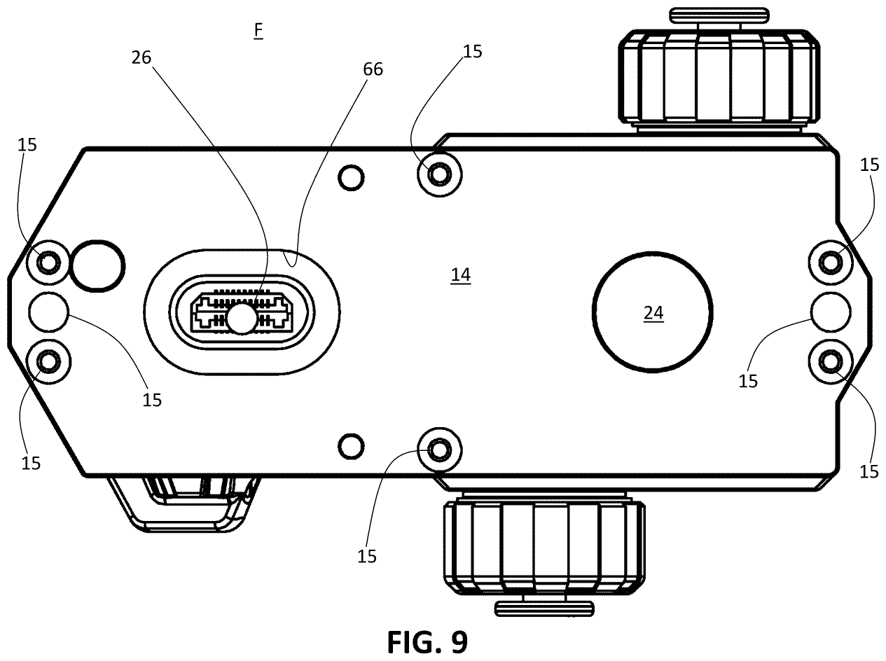

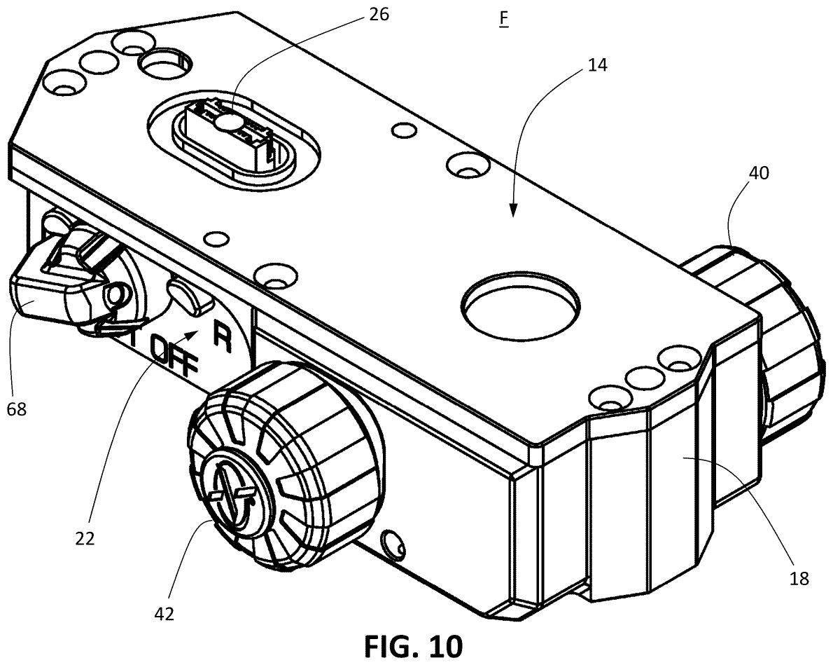

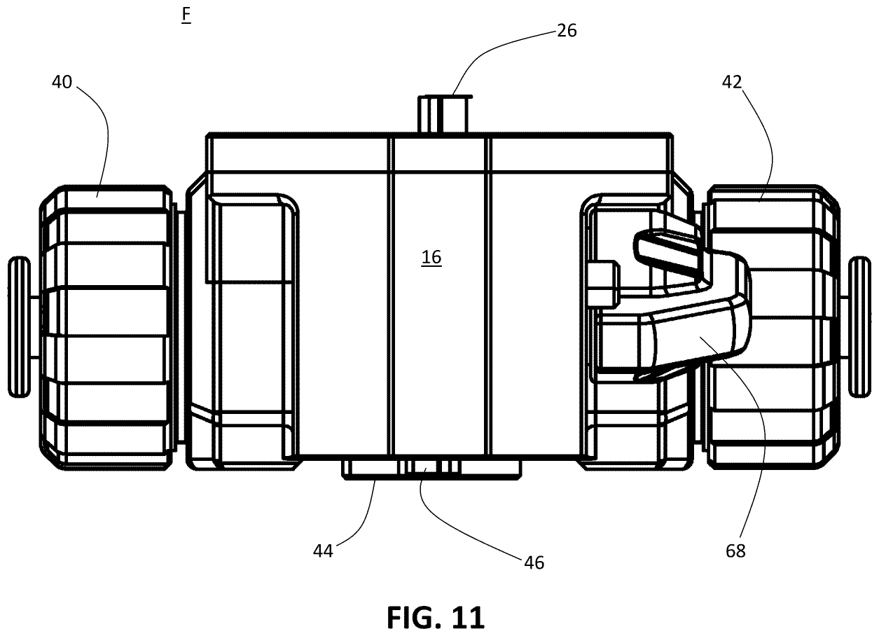

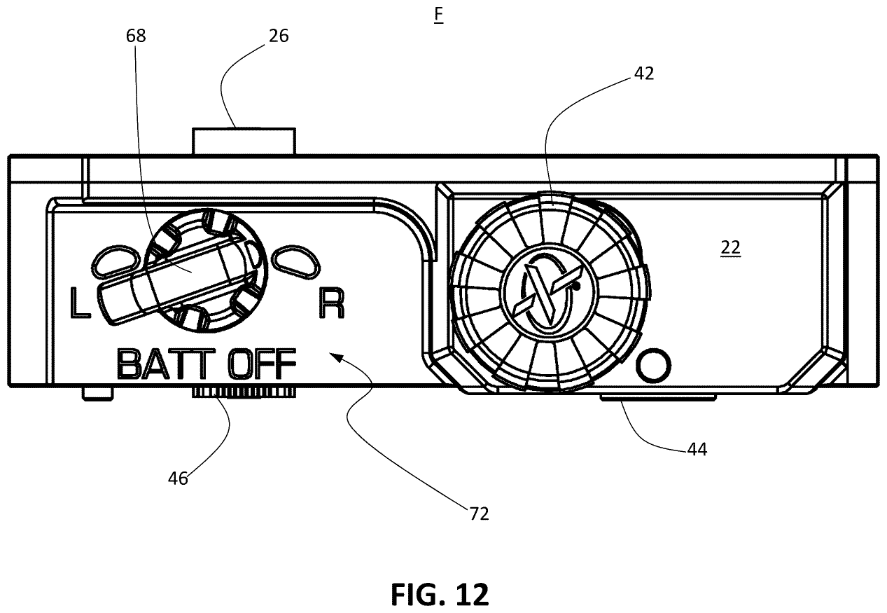

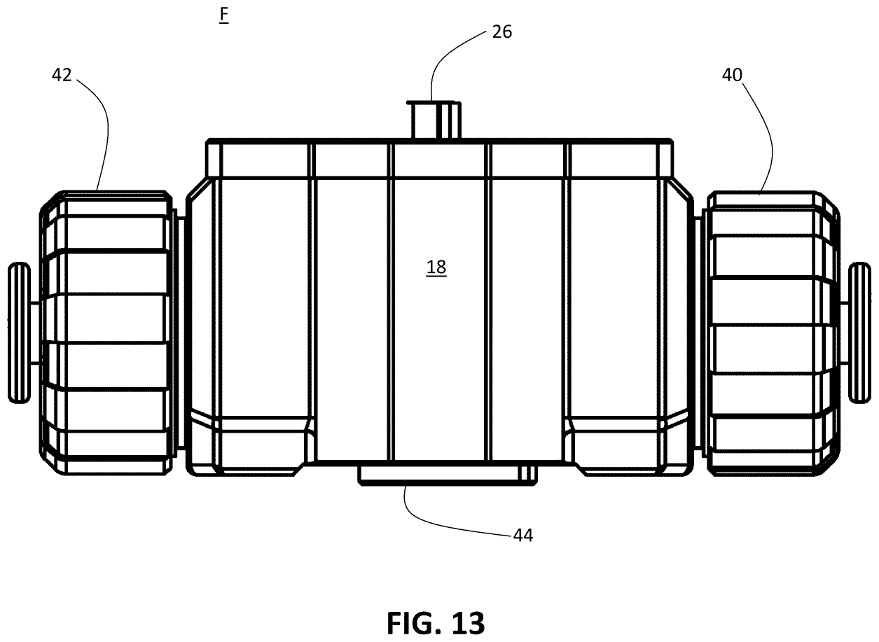

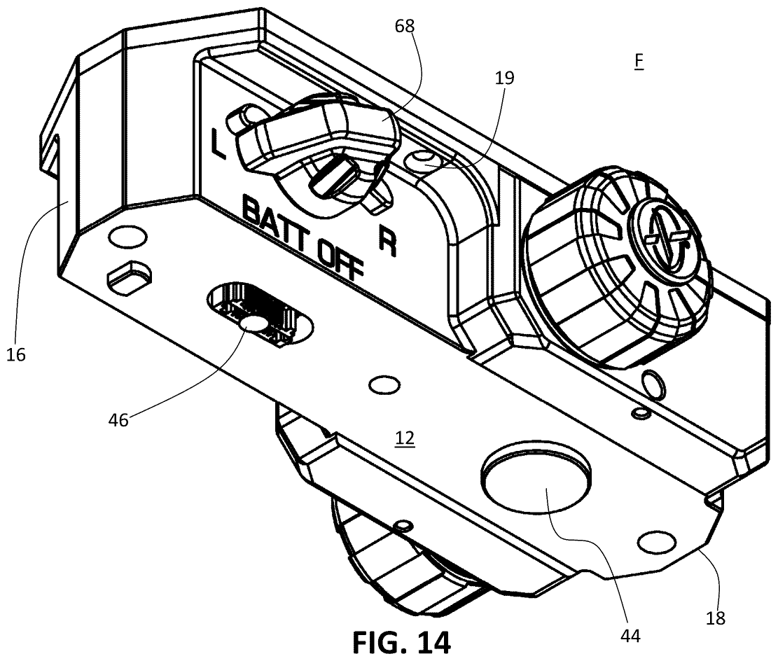

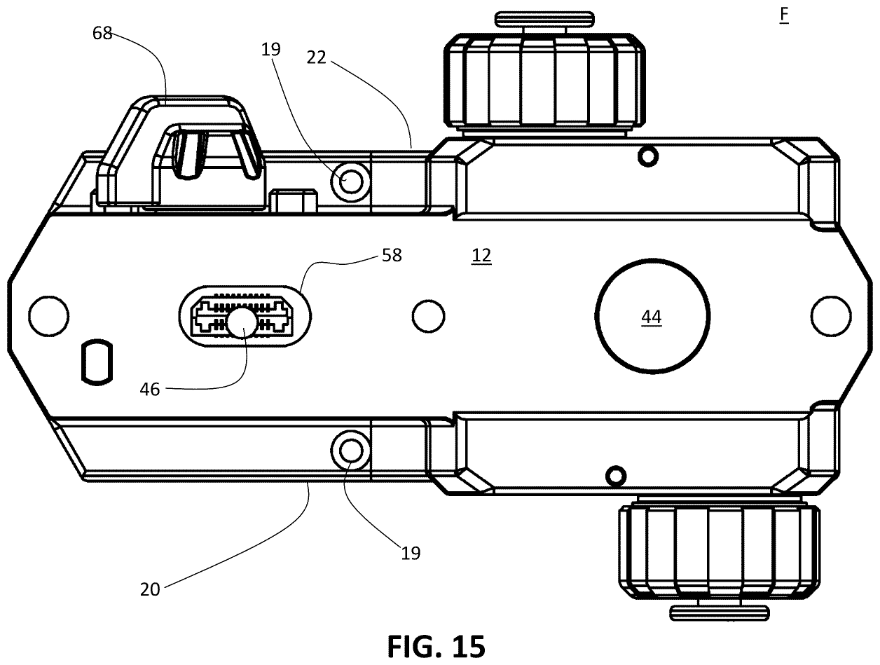

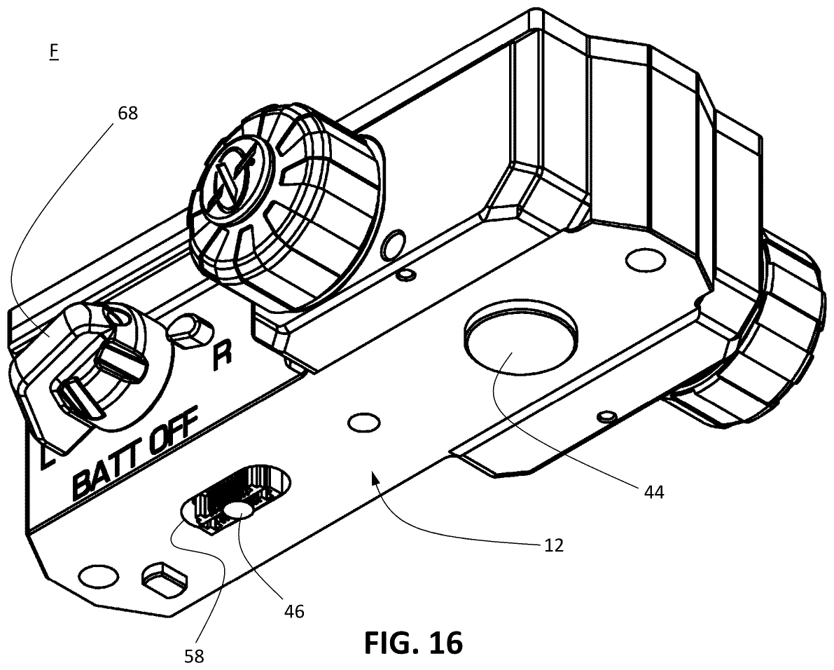

Referring now to FIGS. 8-16, and with continued reference to FIGS. 1-7 and 7A, the riser assembly F includes a main housing 10, a lower surface 12, which interfaces with the weapon accessory interface, and an upper surface 14, which interfaces with the fire control system G. A front side 16, rear side 18, right side 20, left side 22 define a peripheral wall extending between the lower and upper surfaces 12, 14, respectively.

In the illustrated embodiment, the upper surface 14 includes a recess 24 and an electrical connector 26, which extends through an aperture 66 in the upper surface 14. In embodiments, the recess 24 engages with a complementary protrusion or boss (not shown) to ensure that the fire control system G is properly aligned when assembled to the riser assembly F and provides stability against movement or slippage under external forces or vibrations, such as recoil forces generated when the weapon A is fired. In the illustrated embodiment, the upper surface 14 is configured a cover plate secured to the peripheral wall via a plurality of threaded fasteners (not shown) engaging clearance openings 15 in the upper surface 14 and threadably engaging aligned openings 17 in the upstanding wall defined by the front side 16, rear side 18, right side 20, and left side 22. Threaded fasteners (not shown) engage clearance openings 19 in the side walls 20, 22 and threadably engage aligned openings 21 in the upper plate 14.

The right housing side 20 includes an aperture 28 for receiving a right side battery tube 30, which in turn houses a right battery 32. The left housing side 22 includes an aperture 34 for receiving a left side battery tube 36, which in turn housing a left battery 38. Each of the battery tubes 30, 36 has a removable battery cap 40, 42, respectively, to allow access to the batteries 32, 36 for removal and replacement when they run out of power.

In the illustrated embodiment, the lower surface 12 includes a protrusion 44 and an electrical connector 46. The electrical connector is received within an aperture 58 disposed on the housing lower surface 12. In embodiments, the lower surface 12 is configured as a removable plate covering an interior compartment 48 housing a riser circuit assembly 50.

As best seen in FIG. 17, and with continued reference to FIGS. 1-7, 7A, and 8-16, the weapon accessory interface includes a riser mounting portion 52. The surface of the riser mounting portion 52 engages the lower surface 12 of the riser main housing 10. The riser mounting portion 52 includes a recess 54 which engages and is complementary in shape with the protrusion 44. The interlocking nature of the recess 54 and protrusion 44 ensures that the riser assembly F is properly aligned when assembled to the weapon accessory interface and provides stability against movement or slippage under external forces or vibrations, such as recoil forces generated when the weapon A is fired.

The riser mounting portion 52 also includes an aperture 56 configured to accommodate an electrical connector 60. The electrical connector is structured and operable to mate with the electrical connector 46 on the lower housing surface 12.

The riser circuit assembly 50 includes a circuit substrate 62, preferably a flexible circuit substrate, having the lower connector 46 and the upper connector 26 thereon. The riser circuit assembly 50 also includes a switch assembly 64. The switch assembly 64 comprises an actuator knob 68 and a 3-position rotary switch 70. The switch is operable to provide distinct electrical pathways corresponding to a left or “L” position which couples the riser circuit assembly 50 to the left battery 38; a right or “R” position which couples the riser circuit assembly 50 to the right battery 32, or a “battery off” position which disengages or isolates both power sources 32, 38 to prevent unintentional operation. In embodiments, markings or indicators 72 representative of the selected position are provided on the housing 10.

In certain embodiments, the circuitry on the riser circuit assembly 50 includes one or more capacitors (not shown) for storing electrical energy to act as a temporary power supply for brief periods to ensure that power to the connector 26 is not interrupted when switching between the left and right batteries 38, 32. This is particularly advantageous when an attached fire control system F is a processor-based device that requires a reboot after power is lost or cycled. In certain embodiments, each battery 32, 38 is individually swappable such that when one battery is depleted it can be changed without affecting the operation of the devices being powered by the other battery.

The fire control system G includes an electrical connector 74 (see FIG. 45) which mates with the electrical connector 26 on the riser assembly upper surface 14.

The connector 60 is disposed on the handguard circuit assembly 80 including a circuit substrate 82. In embodiments, the circuit substrate 82 is a flexible circuit substrate. The handguard circuit assembly 80 extends axially between the riser mounting portion 52 toward the muzzle end of the handguard assembly B. The handguard circuit assembly 80 extends within a passage withing the handguard assembly B, although is it illustrated exteriorly of the handguard in FIG. 17 for ease of exposition.

The handguard circuit assembly 80 is electrically coupled to a circuit assembly 82 within the remote keypad assembly H (or alternately remote keypad assembly H′ as shown in FIGS. 36-44). The handguard circuit assembly 80 includes an electrical connector element 84.

The flashlight assembly I includes an electrical interface 55, which is operably coupled to an electrical interface 57 on the handguard interface assembly 90. The handguard interface assembly 90 includes a connector assembly 92 configured to detachably couple to the weapon accessory interface. In embodiments, the connector assembly 92 is compatible with a modular attachment system featuring a series of elongated slots along the handguard or accessory mounting surface wherein accessories are attached affixed using locking T-shaped fasteners inserted into the slots and tightened to secure the accessory in place.

In the illustrated embodiment, the connector assembly 92 is a M-LOK™ connector configured to detachably couple to a selected one of a plurality of slots 94 in the weapon accessory interface. In embodiments, the slots 94 are compatible with an M-LOK™ (Magpul Industries Corp., Austin, TX) compatible mounting interface or similar system. It will be recognized that other types of weapon accessory interfaces are also contemplated.

The connector assembly 92 is coupled to an electrical cable 96 which has an electrical connector 98 disposed at the distal end thereof. In operation, the cable 96 is disposed interiorly of the handguard assembly B. The electrical connector 98 is disposed with a complementary notch 100 within the handguard assembly B and electrically engages with the connector 84.

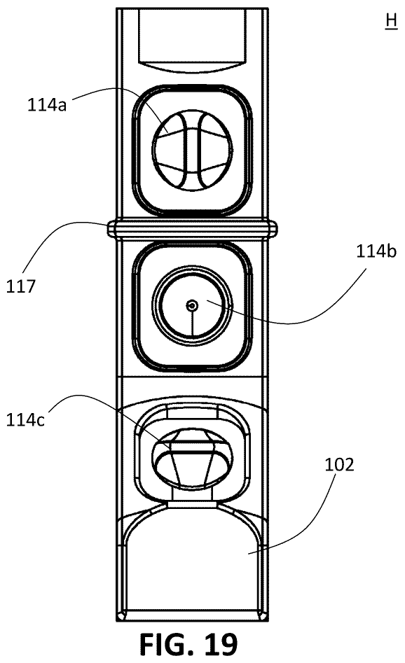

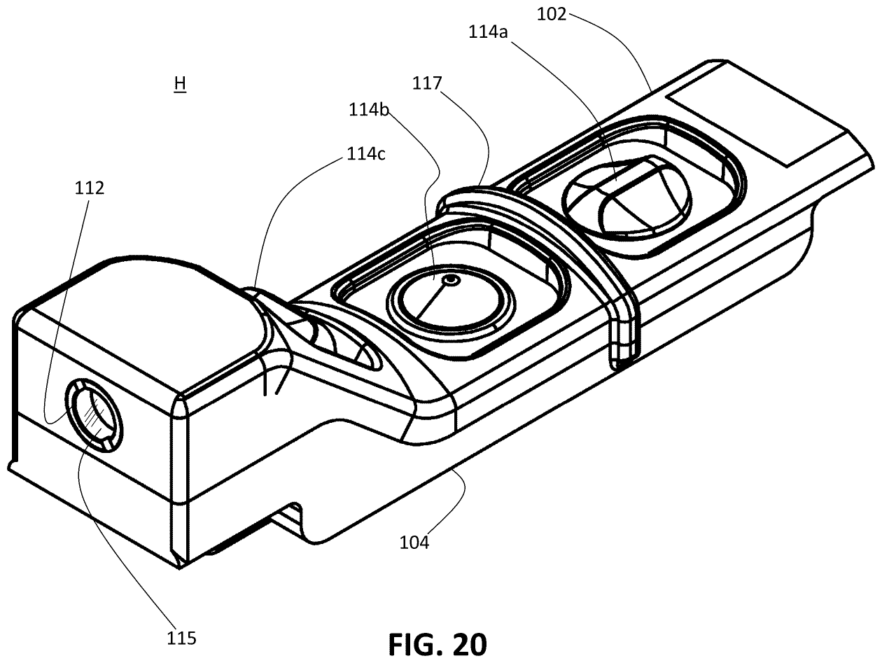

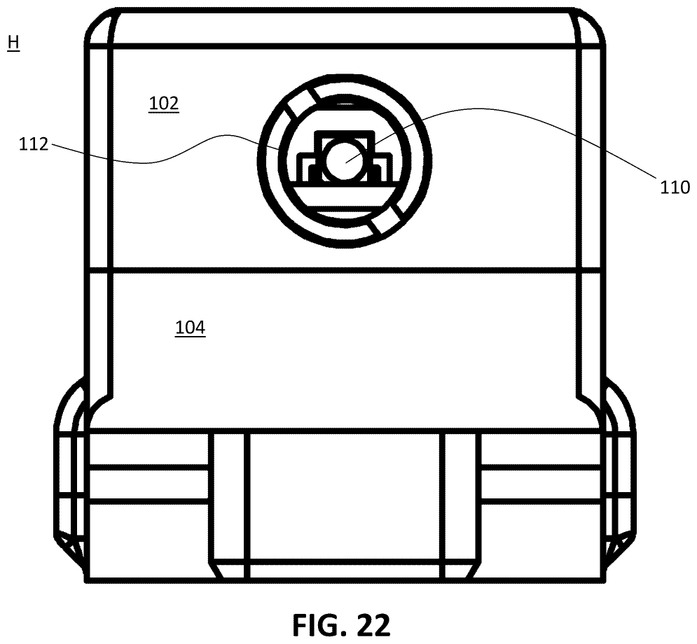

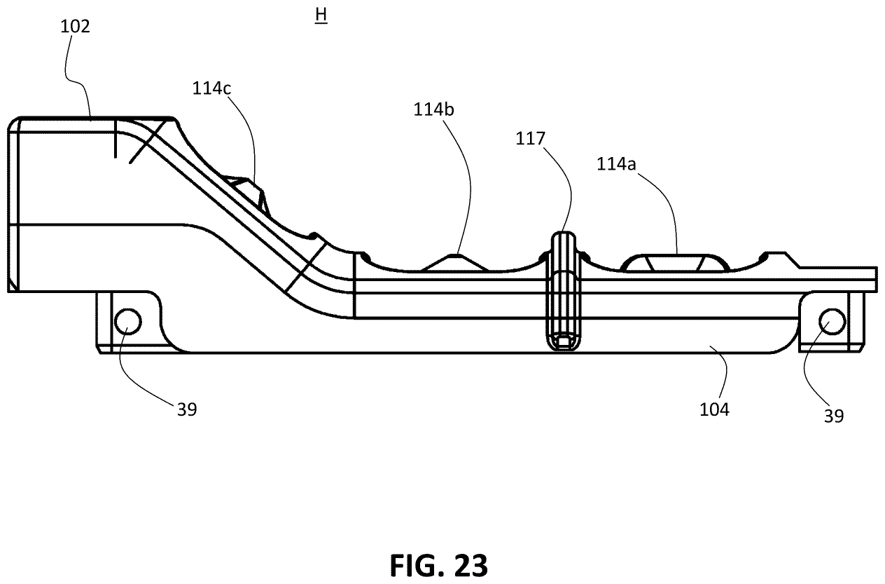

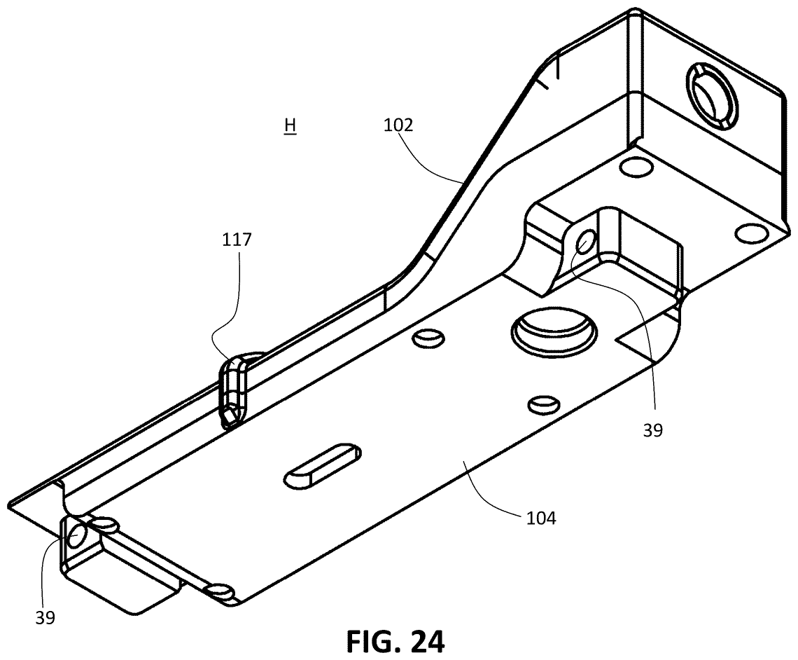

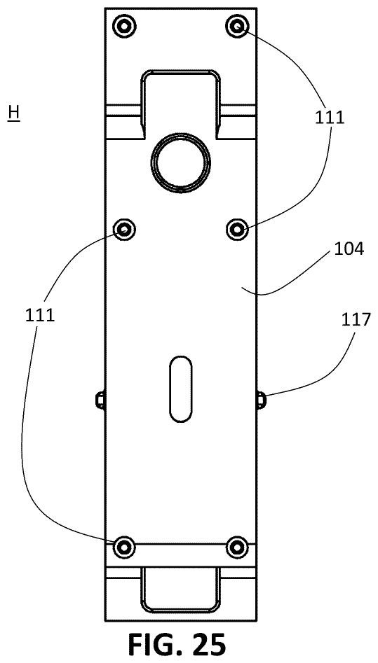

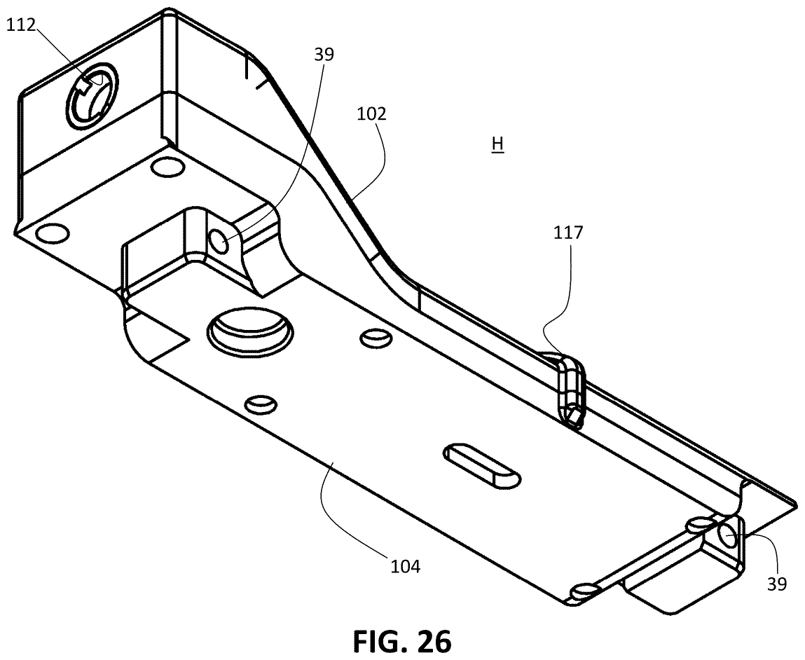

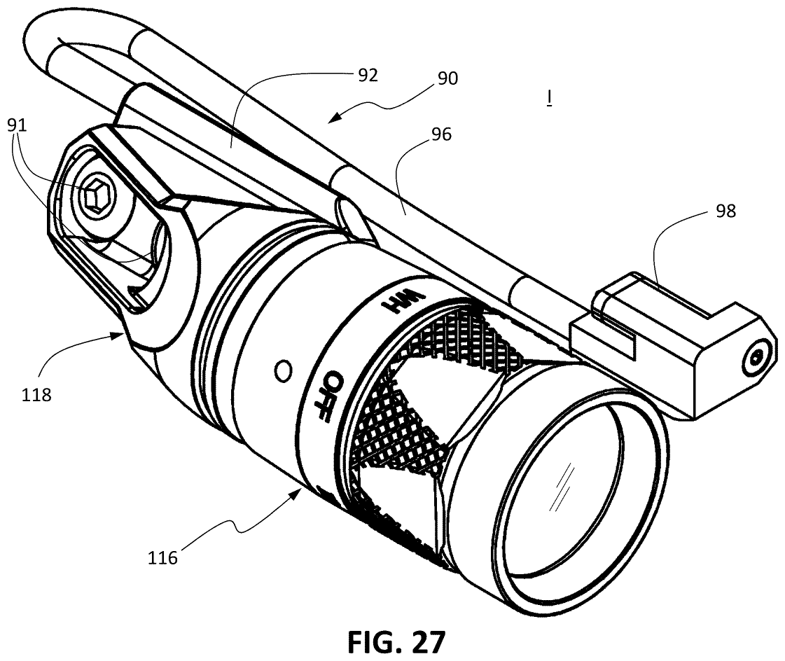

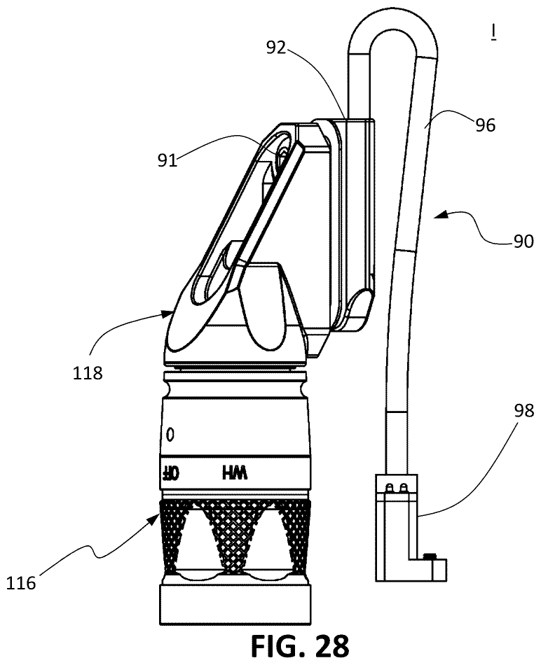

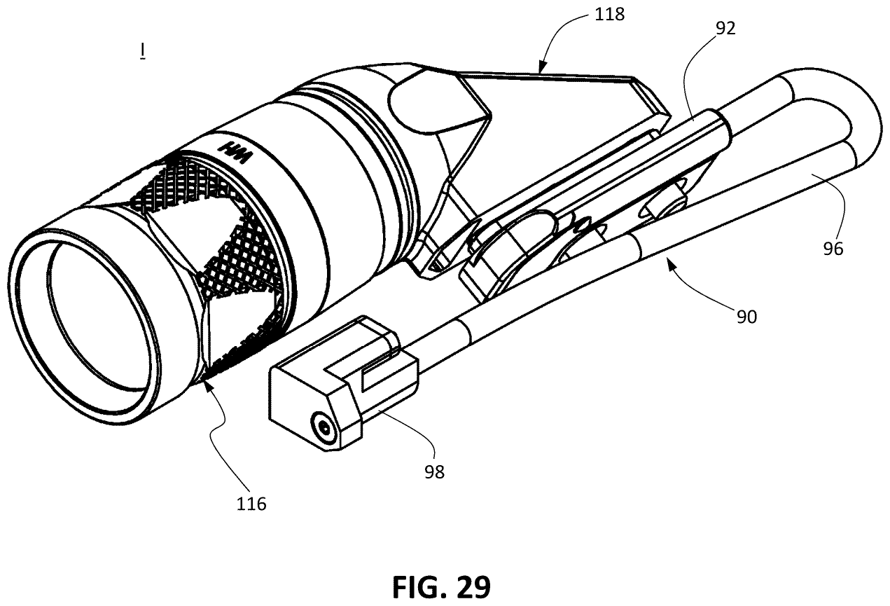

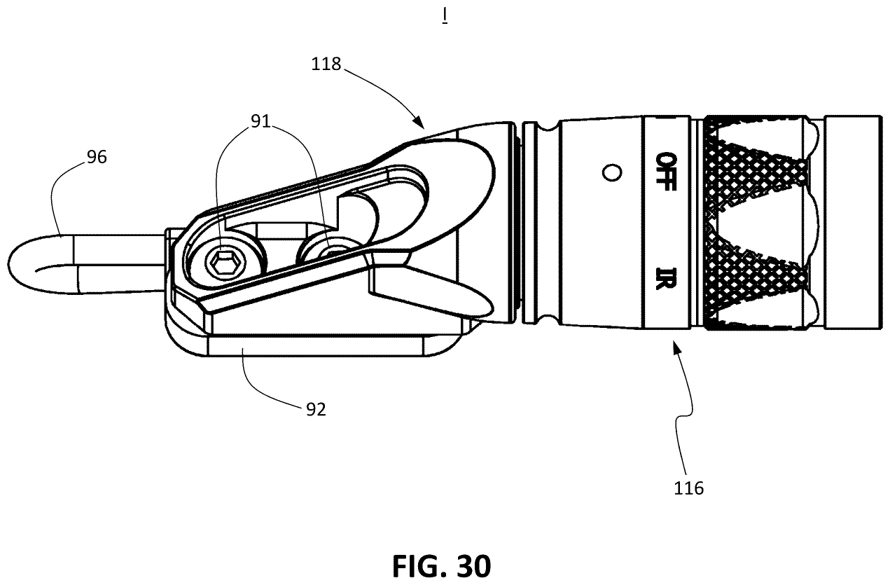

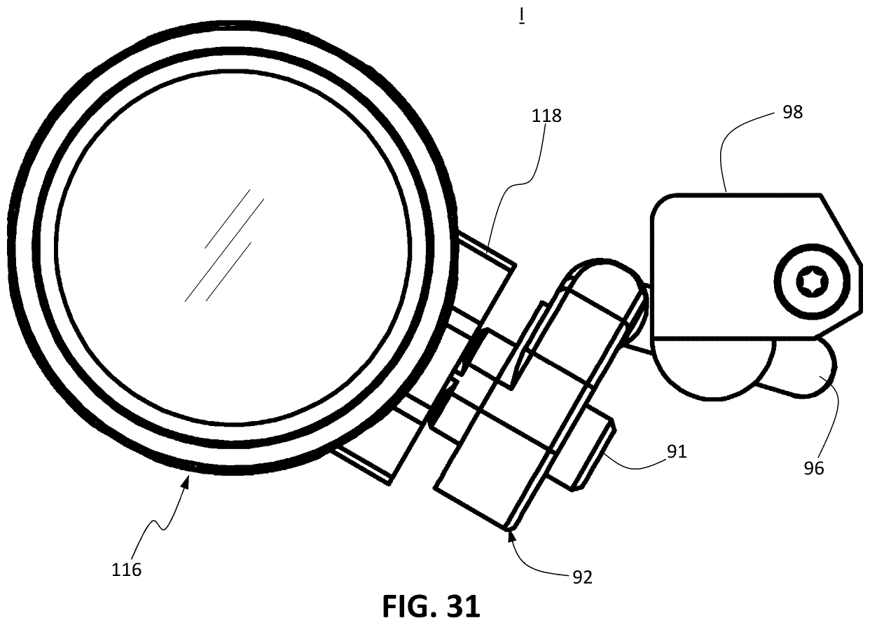

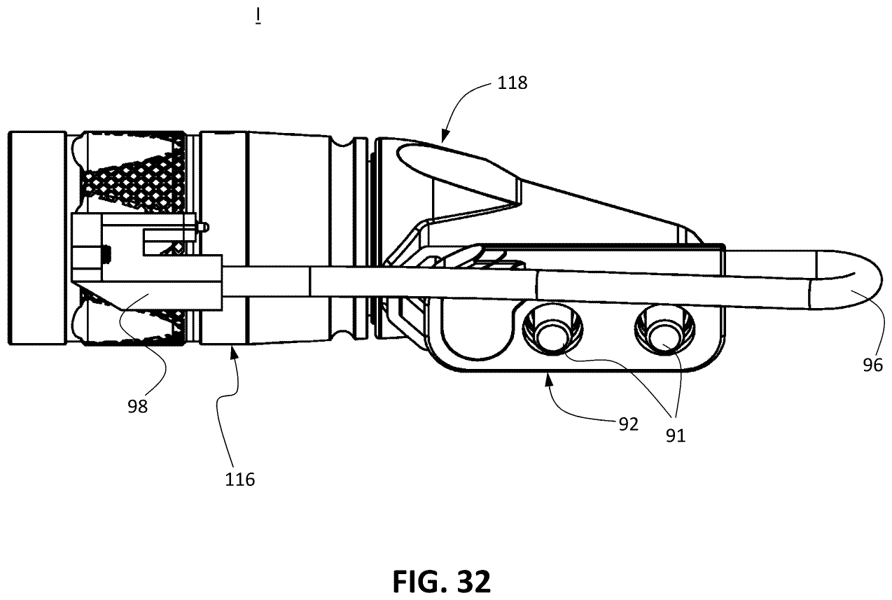

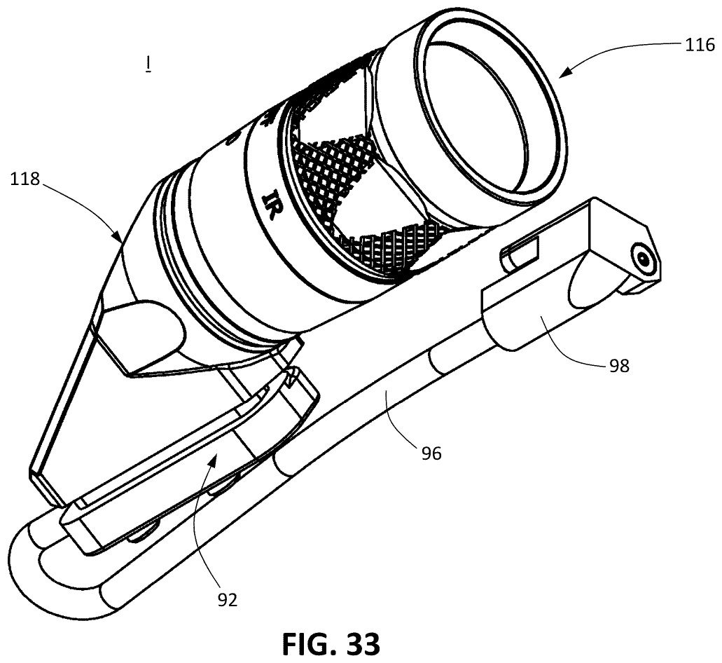

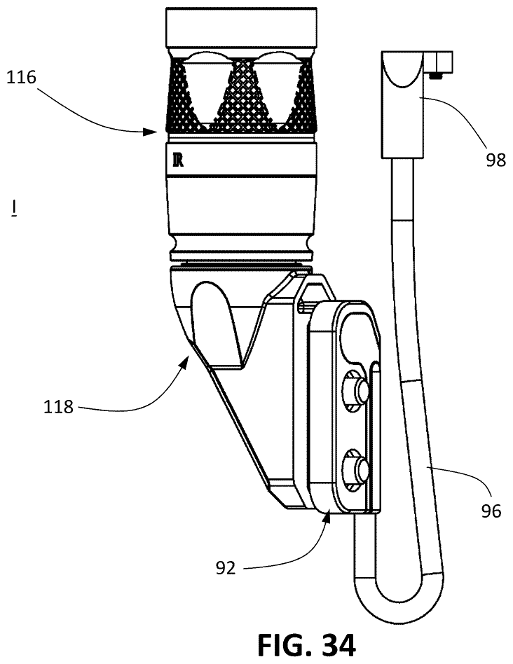

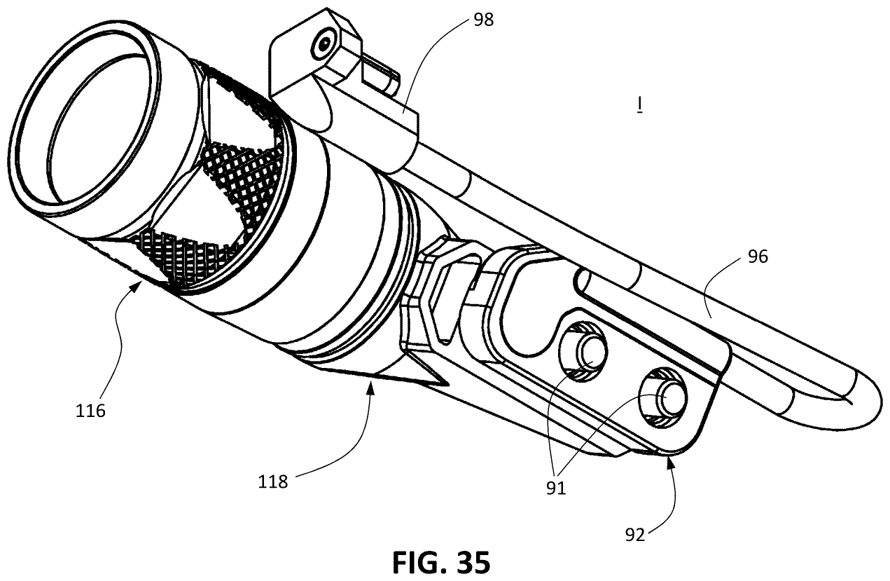

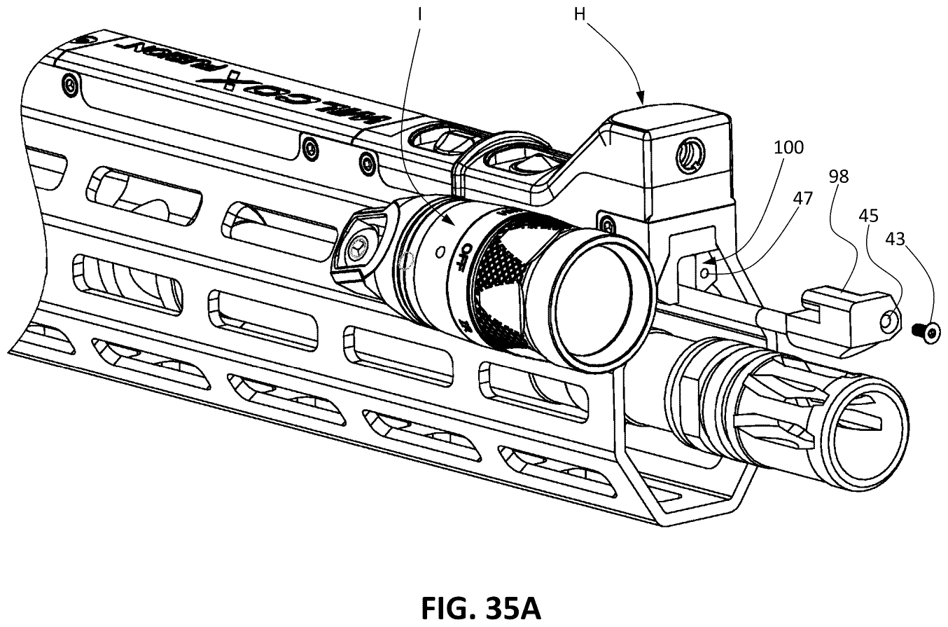

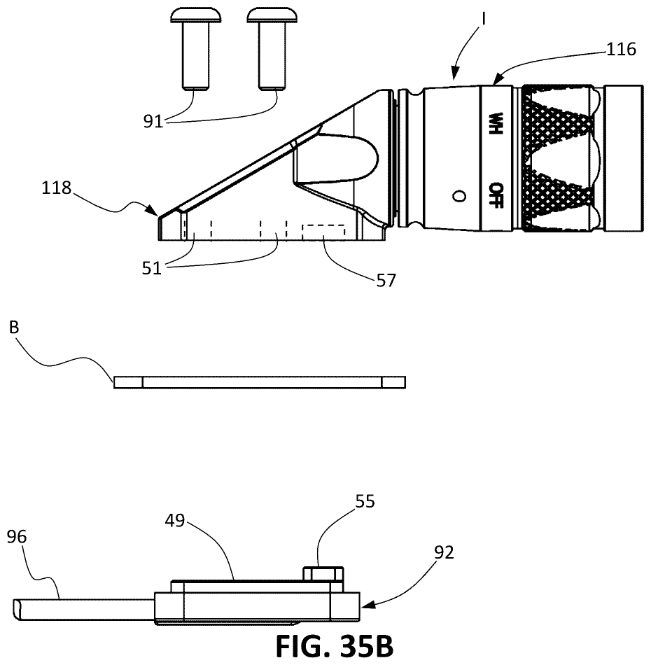

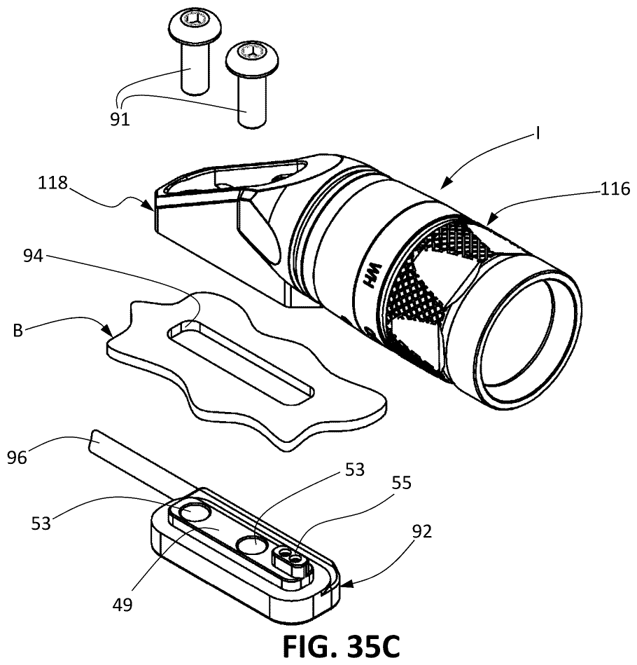

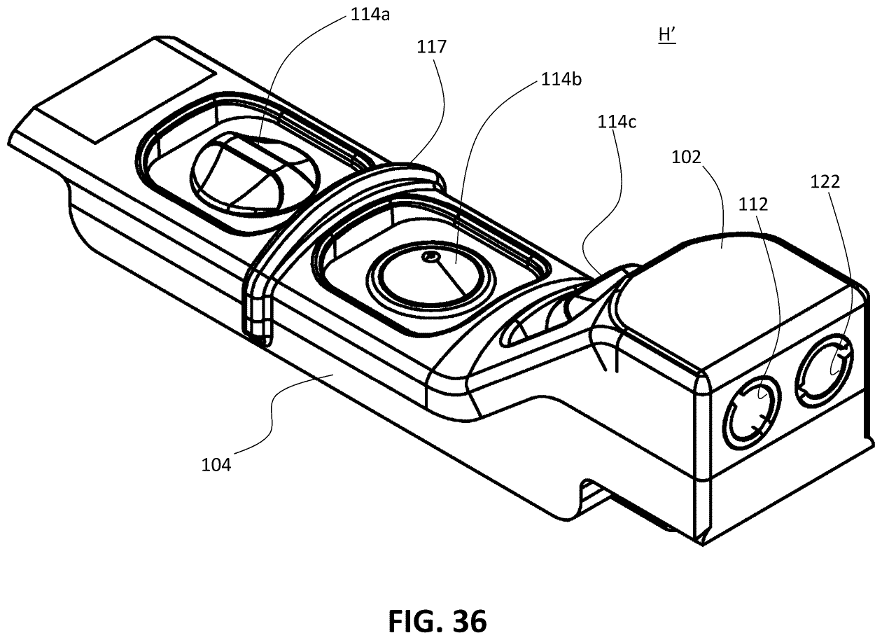

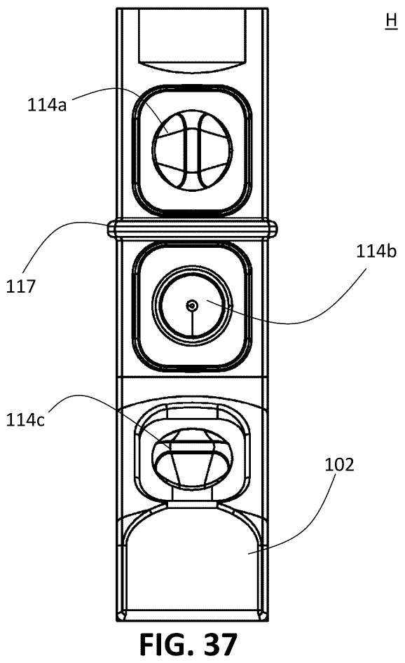

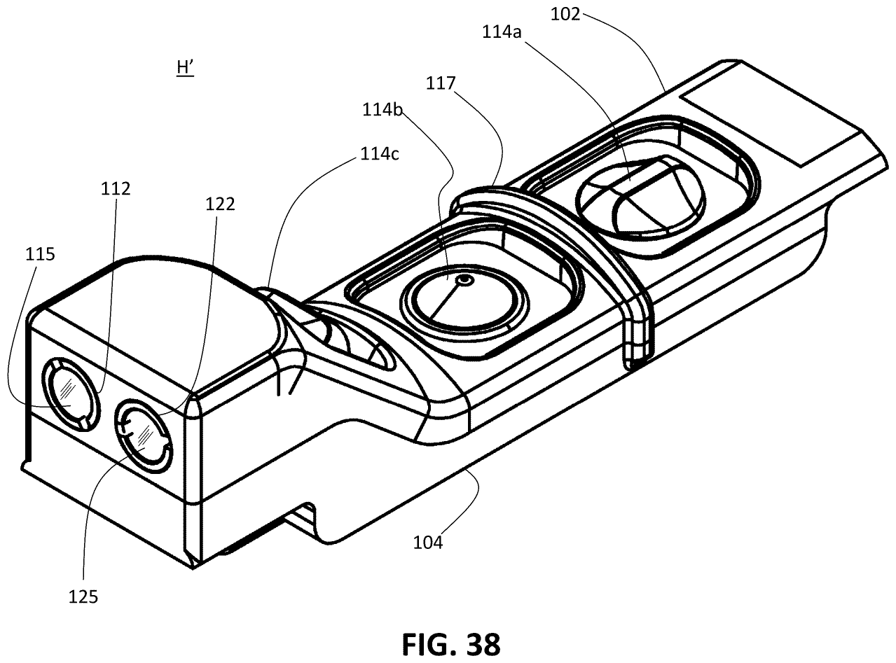

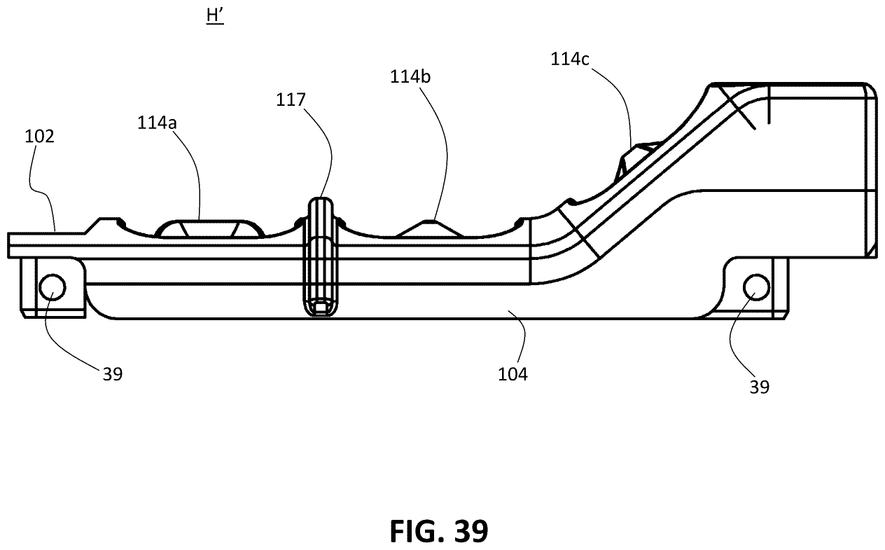

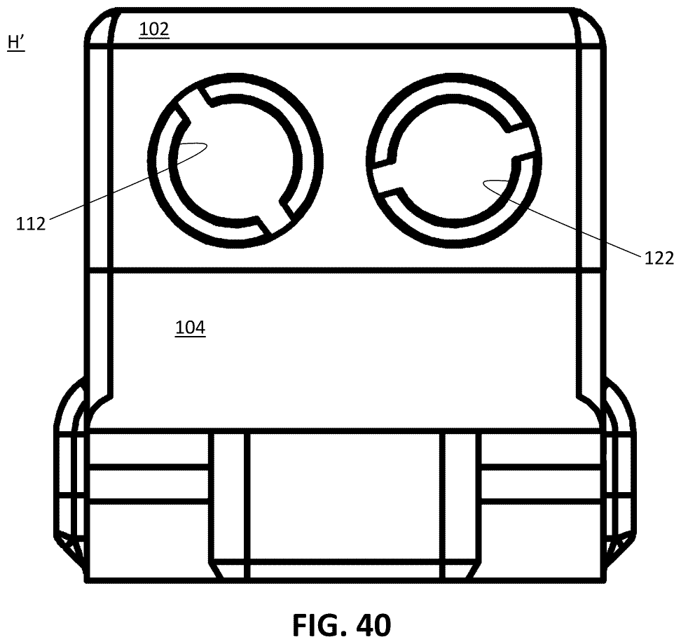

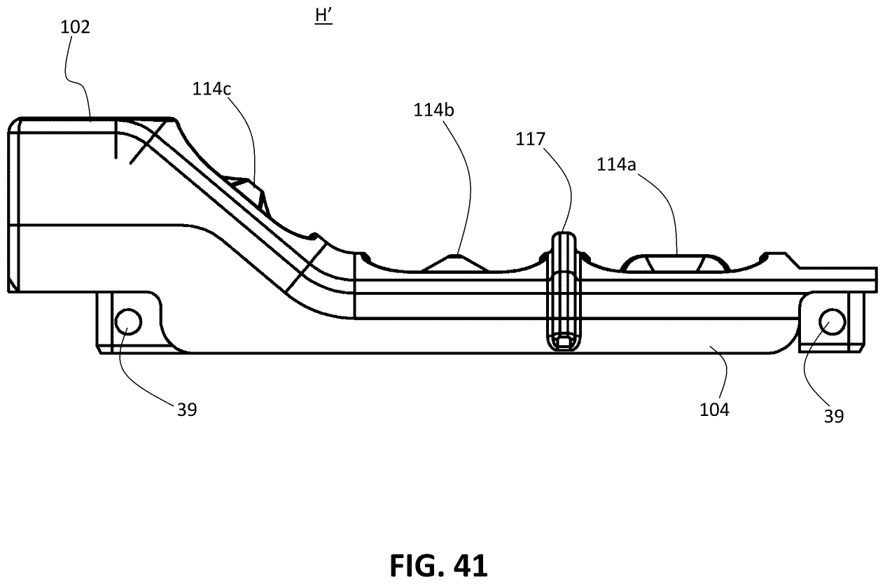

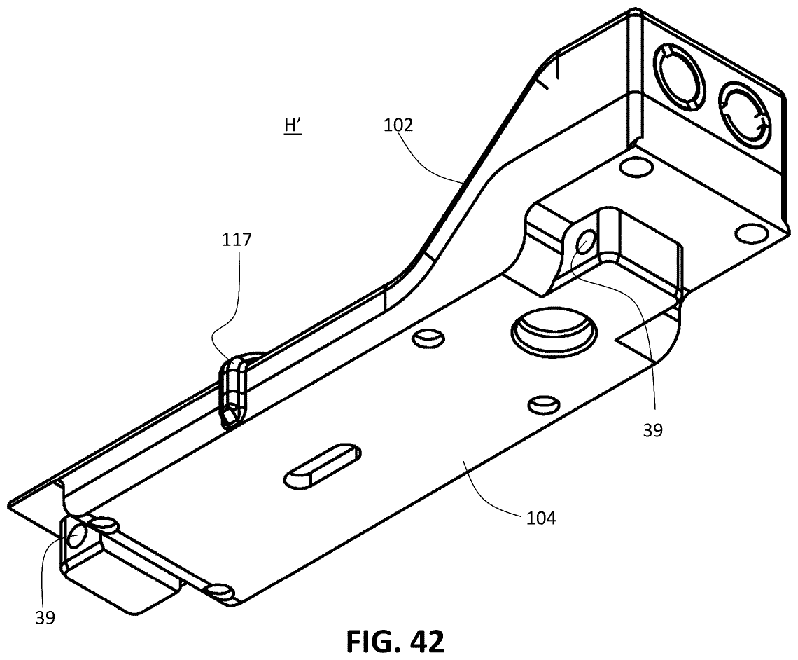

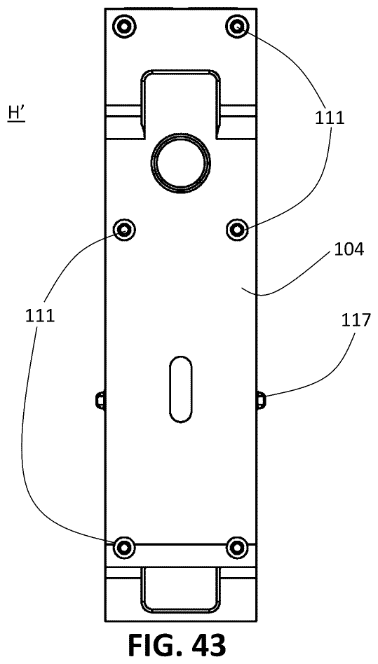

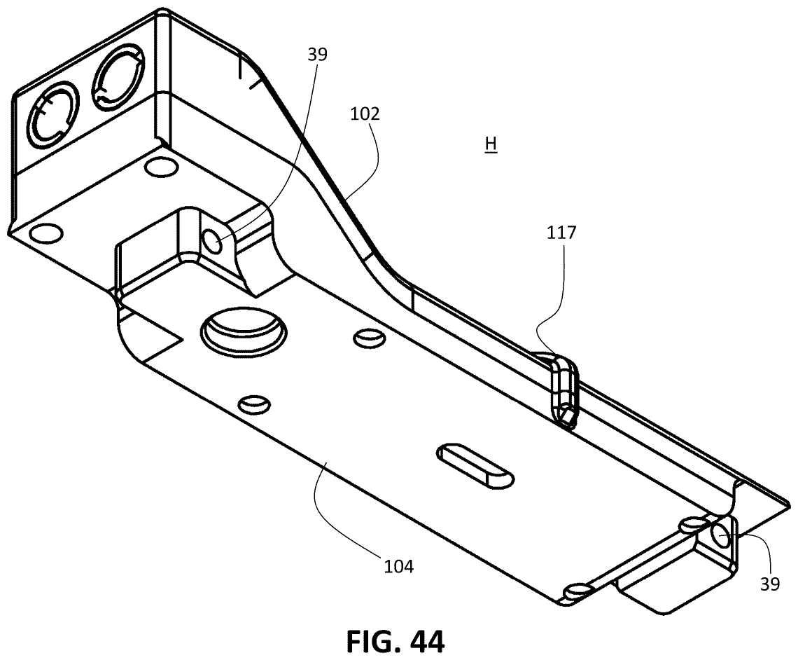

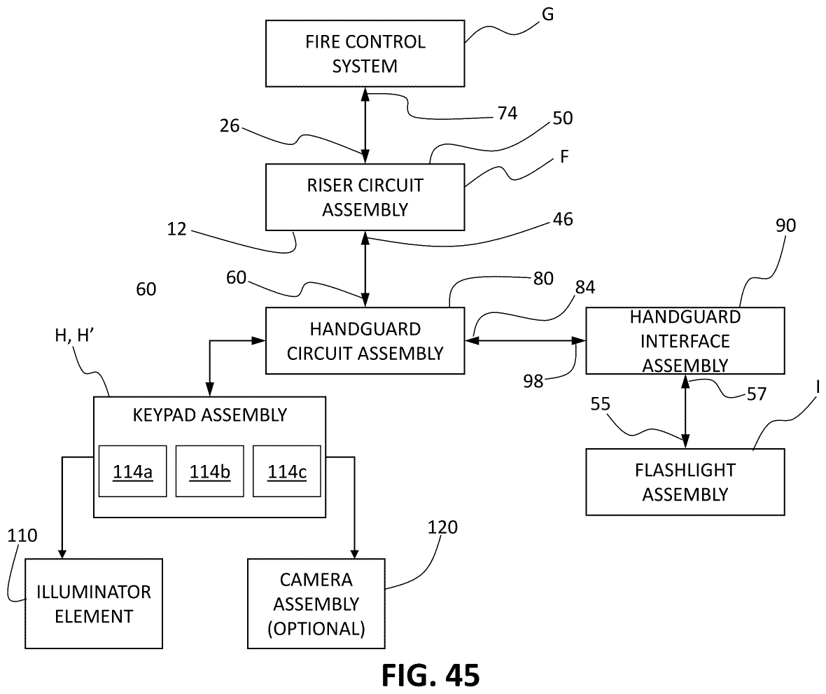

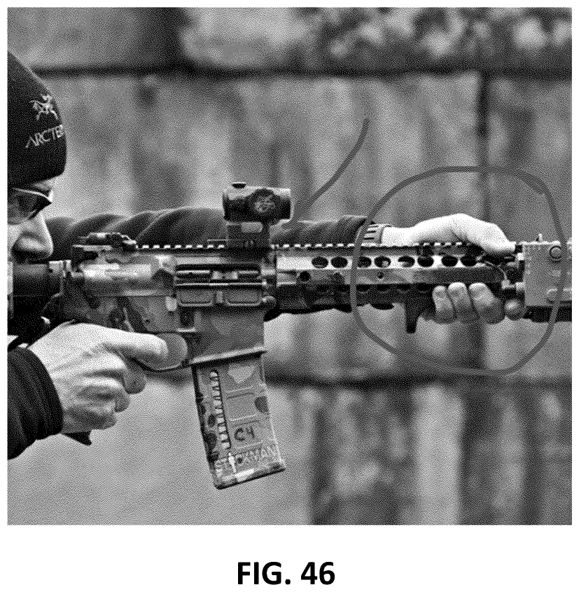

Referring now to FIGS. 18-26 and with continued reference to FIGS. 1-7, 7A, 8-17, and 45, The keypad assembly H includes a housing comprising an upper housing shell 102 and a lower housing shell 104. A keypad circuit assembly 106 is received within an interior compartment 108 within the housing assembly 102, 104. The keypad circuit assembly 106 is operably and electrically coupled to the handguard circuit assembly 80. In embodiments, the shells 102, 104 are secured via threaded fasteners (not shown) passing through clearance openings 111 in the shell 104 and threadably engaging aligned complementary openings in the shell 102.

A light emitting element 110 is disposed on the keypad circuit assembly 106. The light emitting element 110 may be a light emitting diode (LED), incandescent light source, halogen light source, laser emitter, and so forth. The light emitting element 110 is aligned with a port 112 on the upper shell 102. In certain embodiments, one or more lenses or other optical elements 115, such as one or more refractive or diffractive optical element are disposed within the aperture 112 to focus, spread, or otherwise shape the optical output of the light emitting element 110. In preferred embodiments, the optical output of the light emitting element 110 is in the infrared (IR) range although other wavelengths are contemplated. In preferred embodiments, the light emitting element 110 and associated optics are configured as a wide angle illuminator configured to emit light over a broad area, although embodiments with a more focused or narrower beam angle are also contemplated.

The keypad circuit assembly 106 is operably coupled to a plurality of button or key actuated switches 114a, 114b, 114c. The keypad assembly H and light emitting element 110 are powered by the riser assembly F. In operation the light emitting element 110 and switches 114a, 114b, 114c are configured to be electrically coupled to a selected one of the batteries 32, 36. The light emitting element 110 can be activated by the keypad buttons or by user interface elements disposed on the fire control system G which are coupled to the keypad assembly H via the riser assembly F. The forward mounting position of the light emitting element 110 on the housing shell 102 allows for minimum interference of the optical beam due to shadowing caused by the barrel of the weapon. The forward mounting position also minimizes reflections off the muzzle of the weapon back into the operator's field of view. In embodiments, the keypad assembly H can be moved to multiple positions along the handguard of the weapon to allow for user preference.

In embodiments, the switches 114a, 114b, 114c are provided with different switch covers having distinctive shapes or features to enable operation without the need for visual confirmation of the button being selected. In embodiments, the button 114a has a longitudinal ridge, the button 114b has a dome or smooth shape, and the button 114c has a transverse ridge. Other shapes or configurations are also contemplated. Allowing the operator to identify the desired button tactically enhances operational efficiency, minimizes the risk of errors, allows for button identification in low light conditions and in high stakes situations where the need to visualize the buttons could sacrifice situational awareness. In embodiments, a raised rib, ridge, or similar divider 117 is disposed between the buttons 114a, 114b and the button 114c is disposed on an angled or inclined portion of the housing to differentiate it from the other buttons, to allow the operator to activate the desired button without inadvertently pressing the wrong button or multiple buttons simultaneously.

Referring now to FIGS. 27-35 and 35A-35C, and with continued reference to FIGS. 1-7, 7A, 8-26 and 45, The flashlight assembly I includes a flashlight head portion 116 and a body portion 118. In embodiments, the flashlight head 116 includes a light source, such as one or more LEDs or other light emitting elements, such as incandescent, halogen, or laser light sources, a reflector, lens, and bezel, as would be understood by persons skilled in the art. The flashlight assembly I is configured to plug into a common point 100 on the handguard assembly B via the plug 98, and is powered by the power sources 32, 36 within the riser assembly F. In embodiments, the flashlight assembly I does not contain a battery. This allows the flashlight assembly I to be as compact as possible. As best seen in FIG. 35A, the plug 98 is received with the receptacle 100. A threaded fastener 43 passes through a clearance opening 45 in the plug 98, and threadably engages an aligned opening 47 within the connector receptacle 100.

The flashlight body 118 is coupled to the connector assembly 92 attachable to the handguard interface assembly 90 via threaded fasteners 91. The connector assembly is advantageously an M-LOK compatible connector. In FIG. 17, the handguard interface assembly 90 is shown exterior of the handguard assembly B for ease of illustration, although it will be recognized that in operation the connector assembly 92 is disposed within the handguard assembly B with electrical connector elements accessible though the slot 94 to which It is attached. The cable 96 is preferably relatively short and flexible, with sufficient length to allow the flashlight assembly I to be positioned at any point on the perimeter of the handguard assembly B. In this manner, the power routing to the flashlight assembly I is done completely inside the handguard assembly B with no exposed cables.

As best seen in FIGS. 35B and 35C, for ease of illustration, there is shown a fragmentary portion of the handguard assembly B including a mounting slot 94. The connector assembly 92 is disposed within the interior of the handguard assembly B and includes an upstanding boss 49 which is received within and is complementary in shape with the slot 94. The threaded fasteners 91 pass through aligned clearance openings 51 in the flashlight body 118 and through the slot 94 and threadably engage openings 53 in the connector assembly 92. The fasteners 91 provide a clamping force between the flashlight assembly I and the connector assembly 92 to secure the flashlight assembly I to the handguard assembly B. The electrical connector 55 is disposed on the boss 49 and engages the complementary connector 57 on the flashlight body 118 for electrically coupling the flashlight assembly I to the riser assembly F via the handguard circuit assembly 80/

Referring now to FIGS. 36-44, and with continued referenced to FIGS. 1-7, 7A, 8-35, 35A-35C, and 45, there is shown an alternative embodiment keypad assembly H′ which is as described above by way of reference to FIGS. 18-26, except that the keypad assembly H′ additionally houses a camera assembly 120 (see FIG. 45) for imaging a scene within the field of view of the camera assembly 120. The camera assembly 120 includes a lens assembly to capture video footage and a sensor array (e.g., a charge-coupled device (CCD) array or a complementary metal-oxide-semiconductor (CMOS) array) for converting incoming light into electrical signals and a processing unit for storing digital representations of an images scene as would be understood by persons skilled in the art. The camera assembly may be configured to record and/or transmit still images, video images, or both. In situations where additional illumination is required to enhance visibility or highlight specific details within the imaged scene, the integrated light emitting element 110 can be activated. The light emitting element 110 and camera assembly 120 are powered by the batteries 32 36.

The keypad assembly H′ includes a housing comprising an upper housing shell 102 and a lower housing shell 104. A keypad circuit assembly 106 is received within an interior compartment 108 within the housing assembly 102, 104. The keypad circuit assembly 106 is operably and electrically coupled to the handguard circuit assembly 80. In embodiments, the shells 102, 104 are secured via threaded fasteners (not shown) passing through clearance openings 111 in the shell 104 and threadably engaging aligned complementary openings in the shell 102.

A light emitting element 110 is disposed on the keypad circuit assembly 106. The light emitting element 110 may be a light emitting diode (LED), incandescent light source, halogen light source, laser emitter, and so forth. The light emitting element 110 is aligned with a port 112 on the upper shell 102. In certain embodiments, one or more lenses or other optical elements 115, such as one or more refractive, diffractive, or protective optical elements are disposed within the aperture to focus, spread, or otherwise shape the optical output of the light emitting element 110. In preferred embodiments, the optical output of the light emitting element 110 is in the infrared (IR) range although other wavelengths are contemplated. In preferred embodiments, the light emitting element 110 and associated optics are configured as a wide angle illuminator configured to emit light over a broad area, although embodiments with a more focused or narrower beam angle are also contemplated.

The camera assembly 120 is coupled to the keypad circuit assembly 106. The camera assembly 120 is advantageously a digital camera and may be a daytime camera, low light camera, infrared camera, thermal camera, etc., and may be a still image camera or video camera. The camera assembly 120 is aligned with a port 122 on the upper shell 102. In certain embodiments, one or more lenses or other optical elements 125, such as one or more refractive, diffractive, or protective optical elements are disposed within the aperture 122 to focus rays from a scene being imaged.

The keypad circuit assembly 106 is operably coupled to a plurality of button or key actuated switches 114a, 114b, 114c. The keypad assembly H′ light emitting element 110, and camera assembly 120 are powered by the riser assembly F. In operation the light emitting element 110 and switches 114a, 114b, 114c are configured to be electrically coupled to a selected one of the batteries 32, 36. The light emitting element 110 and camera assembly 120 can be activated by the keypad buttons or by user interface elements disposed on the fire control system G which are coupled to the keypad assembly H via the riser assembly F. The forward mounting position of the light emitting element 110 on the housing shell 102 allows for minimum interference of the optical beam due to shadowing caused by the barrel of the weapon. The forward mounting position also minimizes reflections off the muzzle of the weapon back into the operator's field of view. In embodiments, the keypad assembly H can be moved to multiple positions along the handguard of the weapon to allow for user preference.

In embodiments, the switches 114a, 114b, 114c are provided with different switch covers having distinctive shapes or features to enable operation without the need for visual confirmation of the button being selected. In embodiments, the button 114a has a longitudinal ridge, the button 114b has a dome or smooth shape, and the button 114c has a transverse ridge. Other shapes or configurations are also contemplated. Allowing the operator to identify the desired button tactically enhances operational efficiency, minimizes the risk of errors, allows for button identification in low light conditions and in high stakes situations where the need to visualize the buttons could sacrifice situational awareness. In embodiments, a ridge or similar divider 117 is disposed between the buttons 114a, 114b and the button 114c is disposed on an angled or inclined portion of the housing to differentiate it from the other buttons, to allow the operator to activate the desired button without inadvertently pressing the wrong button or multiple buttons simultaneously.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A riser mount system, comprising:
a housing having a lower surface configured to engage a weapon accessory interface; an upper surface opposite the lower surface configured to engage a fire control system; and a peripheral wall extending between the lower surface and the upper surface, the housing defining an interior compartment;
a riser circuit assembly disposed with the interior compartment, the interior compartment configured to receive one or more batteries for electrical coupling to the riser circuit assembly;
a first electrical connector disposed on the first surface and structured and operable to electrically couple the one or more batteries to a fire control system;
a second electrical connector disposed on the second surface and structured and operable to electrically couple the one or more batteries to one or more devices on the weapon accessory interface.

2. The riser mount system of claim 1, in combination with the weapon accessory interface, wherein the weapon accessory interface includes a handguard assembly having a handguard circuit assembly in electrical communication with the riser circuit assembly.

3. The riser mount system of claim 2, wherein handguard assembly includes a plurality of elongated slots.

4. The riser mount system of claim 2, further comprising a keypad assembly electrically coupled to the handguard assembly, the keypad assembly having one or more buttons configured to control operation of the fire control system.

5. The riser mount system of claim 4, wherein the keypad assembly comprises a housing having an integral illuminator disposed within the housing.

6. The riser mount system of claim 5, wherein the housing has a forward facing surface and the integral illuminator is configured to emit light through an aperture in the forward facing surface.

7. The riser mount system of claim 4, wherein the keypad assembly comprises an integral camera assembly disposed within the housing.

8. The riser mount system of claim 7, wherein the housing has a forward facing surface and the integral camera is configured to image light rays entering through an aperture in the forward facing surface.

9. The riser mount system of claim 4, wherein the keypad assembly comprises a housing having an integral illuminator and an integral camera system disposed within the housing.

10. The riser mount system of claim 4, in combination with the fire control system.

11. The riser mount system of claim 2, wherein the handguard assembly includes first and second fastening locations for securing the keypad assembly to the handguard assembly, wherein each of the first and second fastening locations is disposed at a different axial position on the handguard assembly.

12. The riser mount system of claim 11, further comprising a cover plate which is configured to be detachably coupled to a selected one of the first and second fastening locations.

13. The riser mount system of claim 2, wherein the handguard assembly is disposed on an upper surface of the handguard assembly.

14. The riser mount system of claim 1, in combination with the fire control system.

15. The riser mount system of claim 14, wherein the fire control system is a laser sight.

16. The riser mount system of claim 1, further comprising a flashlight assembly configured for detachable coupling to the weapon accessory interface and electrical coupling to the one or more batteries.

17. The riser mount system of claim 16, wherein the flashlight assembly comprises:
a flashlight head having one or more light emitting diodes; and
a flashlight body coupled to the flashlight head.

18. The riser mount system of claim 17, wherein the flashlight assembly does not contain batteries to power the flashlight head.

19. The riser mount system of claim 17, further comprising a flashlight connector assembly, wherein the flashlight connector assembly is configured to detachably couple to the weapon accessory interface at a plurality of positions on the weapon accessory interface.

20. The riser mount system of claim 1, further comprising:
a first battery tube disposed within the interior compartment and configured to receive a first battery;
a second battery tube disposed within the interior compartment and configured to receive a second battery; and
a switch disposed on the housing and configured to selectively electrically couple the first battery and the second battery to the riser circuit assembly and to selectively electrically decouple the first battery and the second battery from the riser circuit assembly.

21. The riser mount system of claim 20, further comprising:
the first battery tube includes a first open end extending through a first opening in the peripheral wall, the first open end being closed by a first removable cover; and
the second battery tube includes a second open end extending through an opening in the peripheral wall, the second open end being closed by a second removable cover.
